(19) United States
(12) Patent Application Publication
(10) Pub. No.: US 2026/0095575 A1
(43) Pub. Date: Apr. 2, 2026

(54) CODING MULTIPLE CONNECTED COMPONENTS IN MESHES

(71) Applicant: Tencent America LLC, Palo Alto, CA (US)

(72) Inventors: Pranav KADAM, Palo Alto, CA (US); Chao HUANG, Palo Alto, CA (US); Shan LIU, San Jose, CA (US)

(73) Assignee: Tencent America LLC, Palo Alto, CA (US)

(21) Appl. No.: 19/302,221

(22) Filed: Aug. 18, 2025

Related U.S. Application Data
(60) Provisional application No. 63/701,876, filed on Oct. 1, 2024.
(60) Provisional application No. 63/708,739, filed on Oct. 17, 2024.

(51) Int. Cl. H04N 19/14; H04N 19/17; H04N 19/597; H04N 19/70

(52) U.S. Cl. CPC H04N 19/14; H04N 19/17; H04N 19/597; H04N 19/70

(57) ABSTRACT

A method for decoding a mesh includes receiving a bitstream including coded information of the mesh that includes a first group of connected components that has a first connectivity. The method includes determining at least one portion of the first connectivity. The at least one portion of the first connectivity is shared by at least one region of each connected component in the first group. The method includes for each connected component in the first group, determining attribute values of vertices in the at least one region of the respective connected component.

### INCORPORATION BY REFERENCE

The present application claims the benefit of priority to U.S. Provisional Application No. 63/701,876 filed on Oct. 1, 2024, and U.S. Provisional Application No. 63/708,739 filed on Oct. 17, 2024. The entire disclosures of the prior applications are hereby incorporated by reference.

### TECHNICAL FIELD

The present disclosure describes aspects generally related to mesh processing.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression may help transmit image/video data across different devices, storage and networks with minimal quality degradation. In some examples, video codec technology may compress video based on spatial and temporal redundancy. In an example, a video codec may use techniques referred to as intra prediction that may compress an image based on spatial redundancy. For example, the intra prediction may use reference data from the current picture under reconstruction for sample prediction. In another example, a video codec may use techniques referred to as inter prediction that may compress an image based on temporal redundancy. For example, the inter prediction may predict samples in a current picture from a previously reconstructed picture with motion compensation. The motion compensation may be indicated by a motion vector (MV).

Advances in three-dimensional (3D) capture, modeling, and rendering have promoted 3D content across various platforms and devices. For example, a baby's first step in one continent is captured and grandparents may see (and in some cases interact) and enjoy a full immersive experience with the child in another continent. In order to achieve such realism, models are becoming more sophisticated, and a significant amount of data is linked to the creation and consumption of those models. 3D meshes are widely used to represent such immersive contents.

### SUMMARY

Aspects of the disclosure include methods and apparatuses for mesh processing.

Aspects of the disclosure include a decoding method for decoding a mesh. In the decoding method, a bitstream including coded information of the mesh that includes a first group of connected components that has a first connectivity is received. At least one portion of the first connectivity is determined. The at least one portion of the first connectivity is shared by at least one region of each connected component in the first group. For each connected component in the first group, attribute values of vertices in the at least one region of the respective connected component are determined.

Aspects of the disclosure also provide an apparatus for mesh decoding. The apparatus for mesh decoding including processing circuitry configured to implement any of the described methods including the decoding method of mesh processing performed in a decoder.

In an aspect, a method of mesh encoding such as encoding a mesh is provided. In the method of mesh encoding, at least one portion of a first connectivity of a first group of connected components in the mesh is determined. The at least one portion of the first connectivity is shared by at least one region of each connected component in the first group. For each connected component in the first group, attribute values of vertices in the at least one region of the respective connected component are determined.

Aspects of the disclosure also provide an apparatus for mesh encoding. The apparatus for mesh encoding including processing circuitry configured to implement any of the described methods of mesh processing performed in an encoder.

In some aspects, the techniques described herein relate to a non-transitory computer readable medium storing a video media bitstream encoded by an encoding method, the encoding method including: determining at least one portion of a first connectivity of a first group of connected components in the mesh, the at least one portion of the first connectivity being shared by at least one region of each connected component in the first group; and for each connected component in the first group, determining attribute values of vertices in the at least one region of the respective connected component.

Aspects of the disclosure also provide a non-transitory computer-readable medium storing instructions which, when executed by a computer, cause the computer to perform any of the described methods for mesh processing.

Technical solutions of the disclosure include coding repeated connected components in a mesh. In some examples, when the mesh includes a group of connected components that have the same connectivity, the connectivity of the connected components in the group is coded only one time. Comparing to coding the connectivity of the connected components multiple times, less bits are used when coding the connectivity of the group only one time. Further, the residue of an already encoded attribute of a first connected component is used to refine the prediction of its corresponding attribute in a second connected component within the same group, for example, when the first and second connected components are related by a rigid transformation. Thus, in some examples, predictor indices are only signaled for the first connected component and are not signaled for the second connected component, and less bits are used in signaling the predictor indices.

In some examples, different connected components in a mesh benefit from different traversal modes depending on the characteristics. Thus, using an adaptive traversal strategy as described in the disclosure for coding multiple connected components in the mesh results in better coding efficiencies. Further, a group of connected components which share the same traversal may be traversed using the same traversal mode to improve coding efficiencies.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 shows an example of an encoding process for mesh processing based on a related video codec according to an aspect of the disclosure.

FIG. 5 shows an example of a decoding process for mesh processing according to an aspect of the disclosure.

FIG. 6 shows an example of a vertex degree of a vertex and a face degree of a face of a mesh according to an aspect of the disclosure.

FIG. 7 shows an example of a primal mesh and a dual mesh according to an aspect of the disclosure.

FIGS. 8-9 show an example of a traversal sequence of a dual-degree algorithm according to an aspect of the disclosure.

FIG. 10 shows an example of a polygon-fan according to an aspect of the disclosure.

FIG. 11 shows an example of topological configurations C0-C8 used to compress a triangle-fan connectivity according to an aspect of the disclosure.

FIGS. 12-13 show examples of predicting a vertex p using two references a₀ and b₀ according to an aspect of the disclosure.

FIG. 14 shows an example of groups of connected components in a mesh according to an aspect of the disclosure.

FIGS. 15-17 show an example of a signaling scheme according to an aspect of the disclosure.

FIGS. 18-19 show an example of a signaling scheme according to an aspect of the disclosure.

FIG. 20 shows a flow chart outlining a decoding process according to some aspects of the disclosure.

FIG. 21 shows a flow chart outlining an encoding process according to some aspects of the disclosure.

FIG. 22 is a schematic illustration of a computer system in accordance with an aspect.

### DETAILED DESCRIPTION

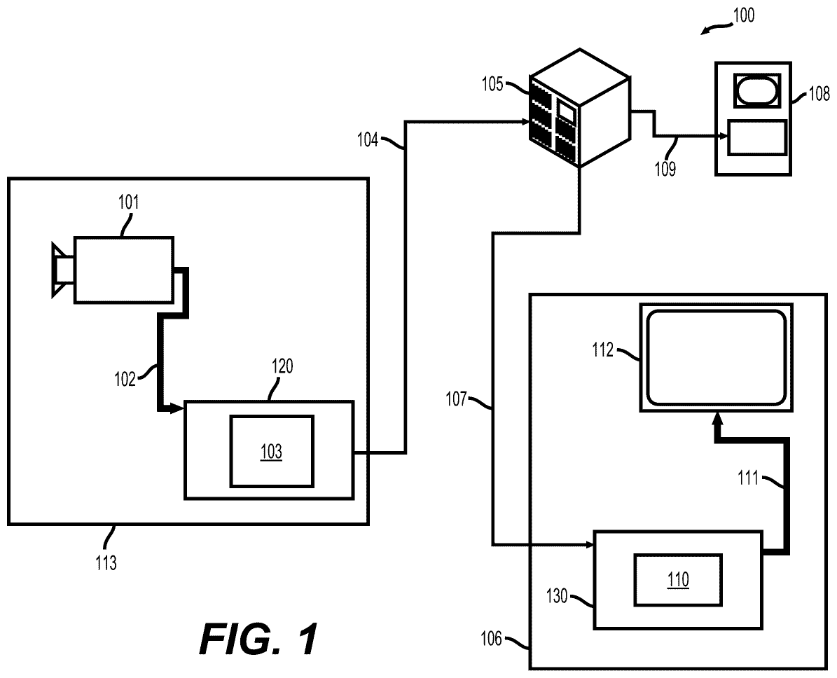

FIG. 1 shows a block diagram of a video processing system (100) in some examples. The video processing system (100) is an example of an application for the disclosed subject matter, a video encoder and a video decoder in a streaming environment. The disclosed subject matter may be equally applicable to other image and/or video enabled applications, including, for example, video conferencing, digital TV, streaming services, storing of compressed video on digital media including CD, DVD, memory stick, and the like.

The video processing system (100) includes a capture subsystem (113), that may include a video source (101). The video source (101) may include one or more images captured by a camera and/or generated by a computer. For example, a digital camera may create a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), may be processed by an electronic device (120) that includes a video encoder (103) coupled to the video source (101). The video encoder (103) may include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), may be stored on a streaming server (105) for future use. One or more streaming client subsystems, such as client subsystems (106) and (108) in FIG. 1 may access the streaming server (105) to retrieve copies (107) and (109) of the encoded video data (104). A client subsystem (106) may include a video decoder (110), for example, in an electronic device (130). The video decoder (110) decodes the incoming copy (107) of the encoded video data and creates an outgoing stream of video pictures (111) that may be rendered on a display (112) (e.g., display screen) or other rendering device (not depicted). In some streaming systems, the encoded video data (104), (107), and (109) (e.g., video bitstreams) may be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) may include other components (not shown). For example, the electronic device (120) may include a video decoder (not shown) and the electronic device (130) may include a video encoder (not shown) as well.

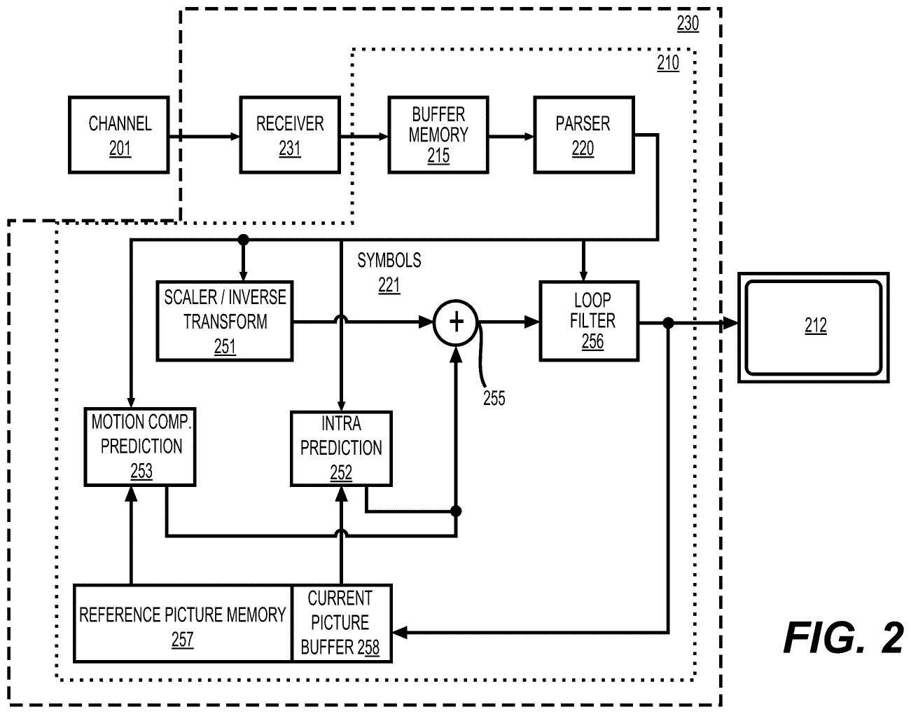

FIG. 2 shows an example of a block diagram of a video decoder (210). The video decoder (210) may be included in an electronic device (230). The electronic device (230) may include a receiver (231). The receiver (231) may include receiving circuitry, such as network interface circuitry. The video decoder (210) may be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it may be outside of the video decoder (210) (not depicted). In still others, there may be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or may be small. For use on best effort packet networks such as the Internet, the buffer memory (215) may be required, may be comparatively large and may be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but may be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence may be in accordance with a video coding technology or standard, and may follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups may include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) may involve multiple different units depending on the type of the coded video picture or parts thereof (such as: inter and intra picture, inter and intra block), and other factors. Which units are involved, and how, may be controlled by subgroup control information parsed from the coded video sequence by the parser (220). The flow of such subgroup control information between the parser (220) and the multiple units below is not depicted for clarity.

Beyond the functional blocks already mentioned, the video decoder (210) may be conceptually subdivided into a number of functional units as described below. In a practical implementation operating under commercial constraints, many of these units interact closely with each other and may, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) may output blocks comprising sample values, that may be input into aggregator (255).

In some cases, the output samples of the scaler/inverse transform unit (251) may pertain to an intra coded block. The intra coded block is a block that is not using predictive information from previously reconstructed pictures, but may use predictive information from previously reconstructed parts of the current picture. Such predictive information may be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) may pertain to an inter coded, and potentially motion compensated, block. In such a case, a motion compensation prediction unit (253) may access reference picture memory (257) to fetch samples used for prediction. After motion compensating the fetched samples in accordance with the symbols (221) pertaining to the block, these samples may be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples may be controlled by motion vectors, available to the motion compensation prediction unit (253) in the form of symbols (221) that may have, for example X, Y, and reference picture components. Motion compensation also may include interpolation of sample values as fetched from the reference picture memory (257) when sub-sample exact motion vectors are in use, motion vector prediction mechanisms, and so forth.

The output samples of the aggregator (255) may be subject to various loop filtering techniques in the loop filter unit (256). Video compression technologies may include in-loop filter technologies that are controlled by parameters included in the coded video sequence (also referred to as coded video bitstream) and made available to the loop filter unit (256) as symbols (221) from the parser (220). Video compression may also be responsive to meta-information obtained during the decoding of previous (in decoding order) parts of the coded picture or coded video sequence, as well as responsive to previously reconstructed and loop-filtered sample values.

The output of the loop filter unit (256) may be a sample stream that may be output to the render device (212) as well as stored in the reference picture memory (257) for use in future inter-picture prediction.

Certain coded pictures, once fully reconstructed, may be used as reference pictures for future prediction. For example, once a coded picture corresponding to a current picture is fully reconstructed and the coded picture has been identified as a reference picture (by, for example, the parser (220)), the current picture buffer (258) may become a part of the reference picture memory (257), and a fresh current picture buffer may be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile may select certain tools as the only tools available for use under that profile from all the tools available in the video compression technology or standard. Also necessary for compliance may be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels may, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data may be in the form of, for example, temporal, spatial, or signal noise ratio (SNR) enhancement layers, redundant slices, redundant pictures, forward error correction codes, and so on.

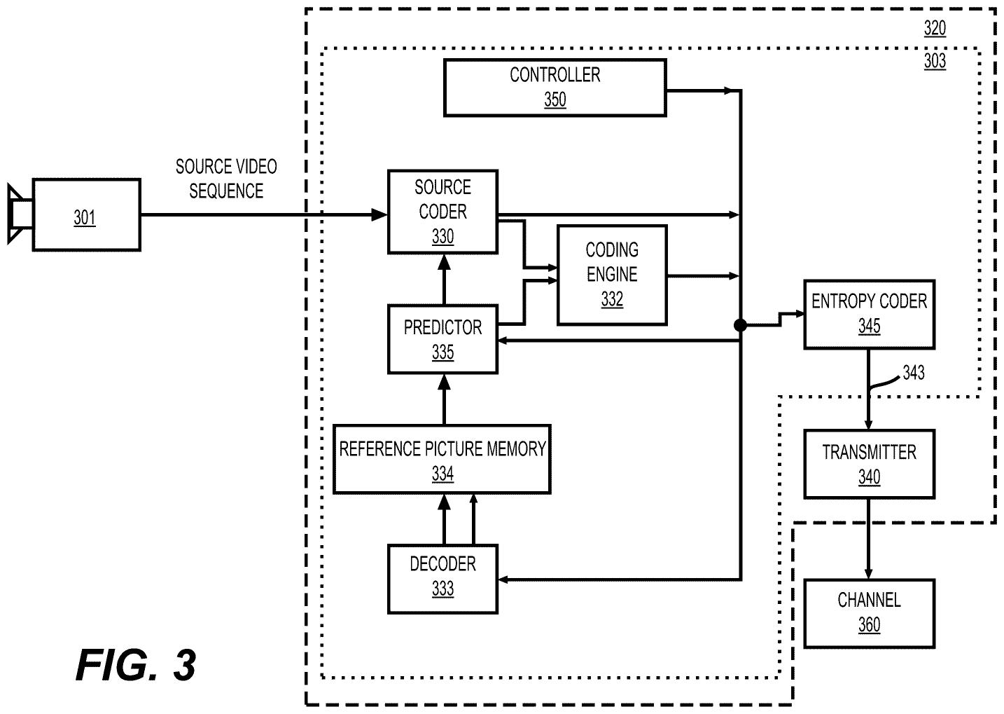

FIG. 3 shows an example of a block diagram of a video encoder (303). The video encoder (303) is included in an electronic device (320). The electronic device (320) includes a transmitter (340) (e.g., transmitting circuitry). The video encoder (303) may be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that may be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel may include one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) may include rate control related parameters (picture skip, quantizer, lambda value of rate-distortion optimization techniques, . . . ), picture size, group of pictures (GOP) layout, maximum motion vector search range, and so forth. The controller (350) may be configured to have other suitable functions that pertain to the video encoder (303) optimized for a certain system design.

In some aspects, the video encoder (303) is configured to operate in a coding loop. As an oversimplified description, in an example, the coding loop may include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity may not be maintained, for example because of channel errors) is used in some related arts as well.

The operation of the “local” decoder (333) may be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) may be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies may be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using at most one motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures may use more than two reference pictures and associated metadata for the reconstruction of a single block.

Aspect of the present disclosure may also be applied to variants of I pictures, P pictures, and B pictures, and their respective applications and features.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may include temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes use of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture may be coded by a vector that is referred to as a motion vector. The motion vector points to the reference block in the reference picture, and may have a third dimension identifying the reference picture, in case multiple reference pictures are in use.

In some aspects, a bi-prediction technique may be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture may be coded by a first motion vector that points to a first reference block in the first reference picture, and a second motion vector that points to a second reference block in the second reference picture. The block may be predicted by a combination of the first reference block and the second reference block.

Further, a merge mode technique may be used in the inter-picture prediction to improve coding efficiency.

According to some aspects of the disclosure, predictions, such as inter-picture predictions and intra-picture predictions, are performed in the unit of blocks, such as a polygon-shaped or triangular block. For example, according to the HEVC standard, a picture in a sequence of video pictures is partitioned into coding tree units (CTU) for compression, the CTUS in a picture have the same size, such as 64×64 pixels, 32×32 pixels, or 16×16 pixels. In general, a CTU includes three coding tree blocks (CTBs), which are one luma CTB and two chroma CTBs. Each CTU may be recursively quadtree split into one or multiple coding units (CUs). For example, a CTU of 64×64 pixels may be split into one CU of 64×64 pixels, 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) may be implemented using any suitable technique. In an aspect, the video encoders (103) and (303) and the video decoders (110) and (210) may be implemented using one or more integrated circuits. In another aspect, the video encoders (103) and (303), and the video decoders (110) and (210) may be implemented using one or more processors that execute software instructions.

The disclosure includes aspects related to methods and apparatuses to predict vertex positions and/or texture coordinates by reflections, parallelogram predictions, and/or the like for mesh compression such as polygon mesh compression. For example, reflection prediction and/or parallelogram predictions of positions and/or UV coordinates in mesh compression such as polygon mesh compression are disclosed.

A mesh may include a plurality of polygons (such as a plurality of polygonal faces) that may describe a surface of a volumetric object. For example, the surface of the volumetric object may be approximated using the mesh. Each polygon of the mesh may be defined by vertices of the corresponding polygon in a three-dimensional (3D) space and information of how the vertices are connected, which may be referred to as connectivity information. In some aspects, vertex attributes, such as colors, normals, displacements, and the like, may be associated with the vertices (also referred to as the mesh vertices). Attributes (also referred to as vertex attributes) may also be associated with the surface of the mesh by exploiting mapping information that parameterizes the mesh with two-dimensional (2D) attribute maps. Such mapping may be described by a set of parametric coordinates, referred to as UV coordinates or texture coordinates, associated with the mesh vertices. 2D attribute maps may be used to store high resolution attribute information such as texture, normals, displacements, and the like. The high resolution attribute information may be used for various purposes such as texture mapping, shading, and mesh reconstruction.

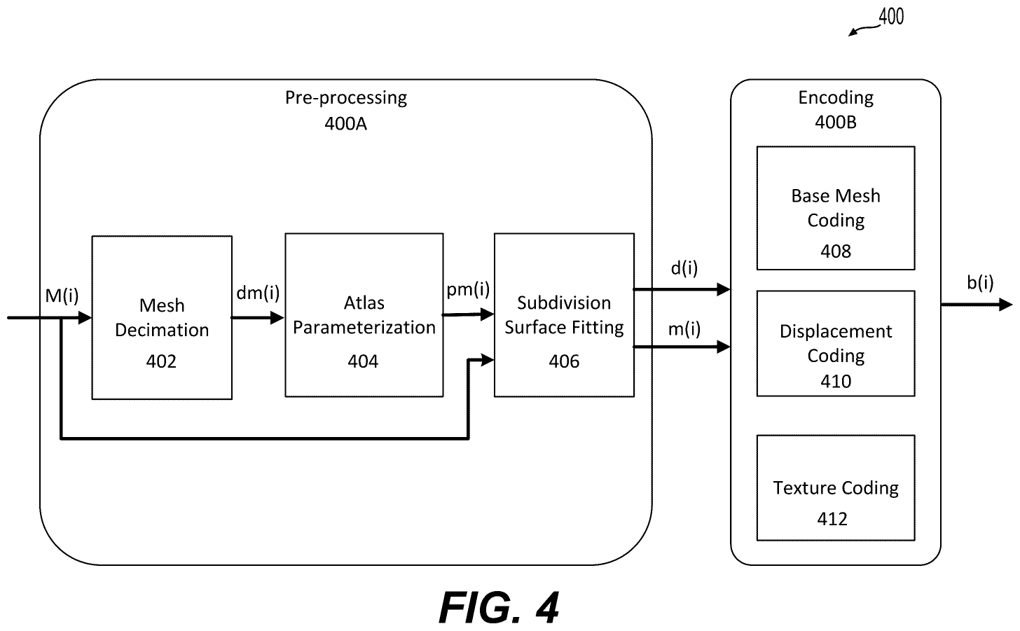

FIG. 4 shows an example of an encoding process (400) for mesh processing based on a related video codec according to an aspect of the disclosure. As shown in FIG. 4, the encoding process (400) may include a pre-processing step (400A) and an encoding step (400B). The pre-processing step (400A) may be configured to generate a base mesh m(i) of a current frame and a displacement field d (i) of the current frame that includes displacement vectors according to an input mesh M(i) of the current frame. The encoding step (400B) may be configured to encode the base mesh m(i), the displacement field d (i), and texture information of the base mesh m(i). The displacement field d (i) of the current frame may include displacement vectors. An index i may refer to the current frame. In an aspect, a mode decision method may be performed in the encoding process (400) to determine whether inter coding (also referred to as inter frame prediction or an inter mode), intra coding (also referred to as intra frame prediction or an intra mode), or the like is applied to the current frame. For example, the mode decision method may compare a cost of an intra mode and a cost of an inter mode and decide a coding mode of the base mesh m(i) of the current frame based on which one of the costs is smaller. In some examples, a skip mode is used to code (e.g., encode or decode) the base mesh m(i). In an example, the skip mode is a special mode of the inter mode. For example, the base mesh m(i) may be intra coded, or inter coded, or coded with the SKIP mode.

Still referring to FIG. 4, the pre-processing step (400A) may include a mesh decimation process (402), a parameterization process such as an atlas parameterization process (404), and a subdivision surface fitting process (406). The mesh decimation process (402) is configured to down-sample vertices of the input mesh M(i) to generate a decimated mesh dm(i) that may include a plurality of decimated (or down-sampled) vertices. A number of the plurality of decimated vertices is less than a number of the vertices of the input mesh M(i). The parameterization process such as the atlas parameterization process (404) is configured to map the decimated mesh dm(i) onto a planar domain, such as onto a UV atlas (or a UV map), to generate a re-parameterized mesh pm(i). In an example, the atlas parameterization may be performed based on a video processing tool, such as a UV Atlas tool. The subdivision surface fitting process (406) is configured to take the re-parameterized mesh pm(i) and the input mesh M(i) as inputs and produce a based mesh m(i) together with the displacement field d (i) that includes the displacement vectors or a set of displacements. In an example of the subdivision surface fitting process (406), pm(i) is subdivided by using a subdivision scheme such as an iterative interpolation to obtain a subdivided mesh. The iterative interpolation includes inserting at each iteration a new point in a middle of each edge of the re-parameterized mesh pm(i). Any suitable subdivision scheme may be applied to subdivide pm(i). The displacement field d (i) is computed by determining a nearest point on a surface of the input mesh M(i) for each vertex of the subdivided mesh.

An advantage of the subdivided mesh may include that the subdivided mesh has a subdivision structure that allows efficient compression, while offering a faithful approximation of the input mesh. The compression efficiency may be obtained due to the following properties. The decimated mesh dm(i) may have a low number of vertices and may be encoded and transmitted using a lower number of bits than the input mesh M(i) or the subdivided mesh. Referring to FIG. 4, the base mesh m(i) may be generated from the decimated mesh dm(i). In an example, the base mesh m(i) is the decimated mesh dm(i). As the subdivided mesh may be generated based on the subdivision method, the subdivided mesh may be automatically generated by the decoder when the base mesh or the decimated mesh is decoded (e.g., there is no need to use any information other than the subdivision scheme and a subdivision iteration count). At the decoder side, the displacement field d (i) may be generated by decoding the displacement vectors associated with the vertices of the subdivided mesh. Besides allowing for spatial/quality scalability, the subdivision structure enables efficient transforms, such as wavelet decomposition, which can offer high compression performance.

The encoding step (400B) may include a base mesh coding (408), a displacement coding (410), a texture coding (412), and the like. The base mesh coding (408) is configured to encode geometric information of the base mesh m(i) associated with the current frame. In an intra encoding, the base mesh m(i) may be first quantized (e.g., using uniform quantization) and then encoded, for example, by the coding mode determined using the mode decision method. The coding mode may be the inter mode, the intra mode, the skip mode, or the like. The encoder used to intra code the base mesh m(i) may be referred to as a static mesh encoder. In the inter encoding, a reference base mesh (e.g., a reconstructed quantized reference base mesh m′ (j)) associated with a reference frame indicated by an index j may be used to predict the base mesh m(i) associated with the current frame indicated by the index i. The displacement coding (410) is configured to encode the displacement field d (i) that is generated in the pre-processing step (400A). The displacement field d (i) may include a set of displacement vectors (or displacements) associated with the subdivided mesh vertices. The texture coding (412) is configured to encode attribute information of the base mesh m(i). The attribute information may include texture, normal, color, and/or the like. The attribute information may be encoded based on a suitable codec, such as High-Efficiency Video Coding (HEVC) or Versatile Video Coding (VVC).

In an aspect, referring to FIG. 4, a mesh encoding process such as the encoding process (400) starts with a pre-processing (e.g., the pre-processing step (400A)). The pre-processing may convert the input mesh M(i) into the base mesh m(i) together with the displacement field d (i) including a set of displacements (or a set of displacement vectors). The encoding step (400B) may compress outputs (e.g., m(i), d (i), and the like) from the pre-processing and generate a compressed bitstream b (i). The compressed bitstream b (i) may include a compressed base mesh bitstream, a compressed displacement field bitstream (also referred to as a compressed displacement bitstream), a compressed attribute bitstream, and/or the like.

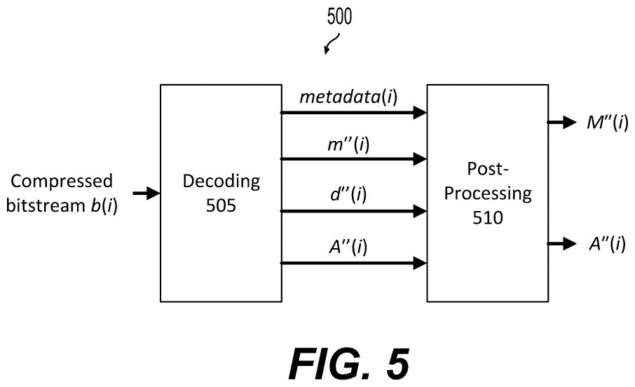

FIG. 5 shows an example of a decoding process (500) for mesh processing according to an aspect of the disclosure. The decoding process (500) may include a decoding step (505) and a post-processing step (510). A compressed bitstream b (i) may be fed to the decoding step (505). In an example, for a lossless transmission, the compressed bitstream b (i) is the output b (i) from the encoding process (400). The decoding step (505) may extract various sub-bitstreams such as the compressed base mesh sub-stream, the compressed displacement field sub-stream, the compressed attribute sub-stream, and/or the like. The decoding step (505) may decompress the sub-bitstreams to generate the following components: patch metadata indicated by metadata (i), a decoded base mesh m″ (i), a decoded displacement field (including displacements) d″ (i), a decoded attribute map A″ (i), and/or the like.

In an aspect, the base mesh sub-stream may be fed to a mesh decoder to generate a reconstructed quantized base mesh m′ (i). The decoded base mesh m″ (i) may be obtained by applying an inverse quantization to m′ (i). The displacement field sub-stream including packed and quantized wavelet coefficients that are encoded may be decoded by a video and/or image decoder. Image unpacking and inverse quantization may be applied to the packed quantized wavelet coefficients that are reconstructed to obtain the unpacked and dequantized transformed coefficients (e.g., wavelet coefficients). An inverse wavelet transform may be applied to the unpacked and dequantized wavelet coefficients to generate the decoded displacement field d″ (i).

The decoded components (e.g., including metadata (i), m″ (i), d″ (i), A″ (i), and/or the like) may be fed to a post-processing step (510). A mesh (also referred to as a decoded mesh) M″ (i) may be generated by the post-processing step (510) based on m″ (i) and d″ (i). In an example, the reconstructed deformed mesh DM(i) may be obtained by subdividing m″ (i) using a subdivision scheme and applying the reconstructed displacements d″ (i) to vertices of a subdivided mesh. In an example, when the encoding process (400), the decoding process (500), and the transmission are lossless, the mesh M″ (i) may be the same as the input mesh M(i). When one of the encoding process (400), the decoding process (500), and the transmission is lossy, M″ (i) is different from M(i). In various examples, the difference, if any, between M″ (i) and M(i) is relatively small. In an example, an attribute map A″ (i) is also generated by the post-processing step (510).

A mesh such as a polygon mesh (also interchangeably referred to as a polygonal mesh) may include topologic quantities, such as vertices, edges, and faces, and geometric quantities, such as attributes including vertex positions, face colors, and the like. Connectivity information of a polygon mesh may describe incidences between elements and may be implied by the topology. For example, two vertices are adjacent when an edge is incident to the two vertices. For example, two faces are adjacent when an edge is incident to the two faces.

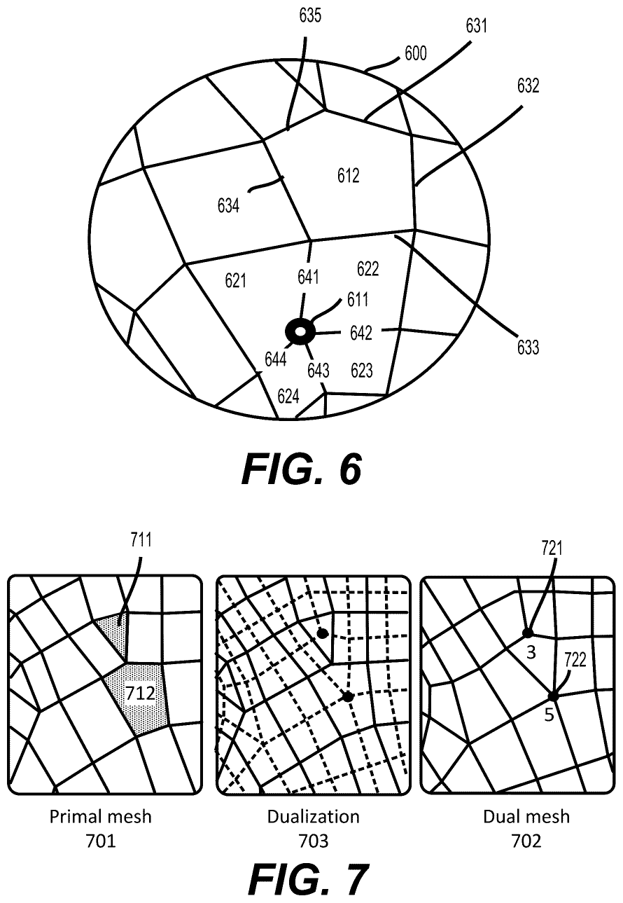

FIG. 6 shows an example of a vertex degree of a vertex (611) and a face degree of a face (612) of a polygon mesh (600) according to an aspect of the disclosure. The polygon mesh (600) may include a plurality of faces that includes the face (612). The polygon mesh (600) may include a plurality of vertices that includes the vertex (611). In an aspect, a vertex degree of a vertex may be interchangeably referred to as a valence of the vertex. A vertex degree of a vertex may specify a number of edges incident to the vertex. Referring to FIG. 6, the vertex degree of the vertex (611) may specify a number of edges (641)-(644) incident to the vertex (611), and the vertex degree of the vertex (611) is 4. A face degree of a face may specify a number of incident edges of the face. Referring to FIG. 6, the face degree of the face (612) may specify a number of incident edges (631)-(635) of the face (612), and the face degree of the face (612) is 5.

In some embodiments, a mesh can include information such as geometry information, connectivity information, mapping information, attributes, and the like. In an aspect, attributes may include vertex attributes and attribute maps. In some examples, the geometry information is described by a set of 3D positions associated with the vertices of the mesh. In an example, (x,y,z) coordinates can be used to describe the 3D positions of the vertices, and are also referred to as 3D coordinates. Referring to FIG. 6, an example of the vertices is the vertex (611). In some examples, the connectivity information includes a set of vertex indices that describes how to connect the vertices to create a 3D surface. In some examples, the mapping information describes how to map the mesh surface to 2D regions of the plane. In an example, the mapping information is described by a set of UV parametric/texture coordinates (u,v) associated with the mesh vertices together with the connectivity information. In some examples, the vertex attributes include scalar or vector attribute values associated with the mesh vertices. In some examples, attribute maps include attributes that are associated with the mesh surface and are stored as 2D images/videos. In an example, the mapping between the videos (e.g., 2D images/videos) and the mesh surface is defined by the mapping information.

In an aspect, UV mapping or mesh parameterization may be used to map faces of a mesh in the 3D domain to the 2D domain. In some examples, a mesh is cut into patches (also referred to as patch components) in the 3D domain. A patch is a contiguous subset of the mesh with a boundary formed of boundary edges. A boundary edge of a patch is an edge that belongs to only one polygon of the patch, and is not shared by two adjacent polygons in the patch. Vertices of boundary edges in a patch are referred to as boundary vertices of the patch, and non-boundary vertices in a patch can be referred to as interior vertices of the patch in some examples.

In an aspect, the patches are parameterized respectively into 2D shapes (also referred to as UV patches, 2D patches, or UV charts) in some examples. The 2D shapes can be packed (e.g., oriented and placed) into a map that is also referred to as a UV atlas in some examples. In some examples, the map can be further processed using 2D image or video processing techniques.

In an example, a UV mapping technique generates a UV atlas (also referred to as UV map) and one or more texture atlas (also referred to as texture map) in 2D corresponding to patches of a 3D mesh. The UV atlas includes assignments of 3D vertices of the 3D mesh to 2D points in a 2D domain (e.g., a rectangular). The UV atlas is a mapping between coordinates of the 3D surface to coordinates of 2D domain. In an example, a point in the UV atlas at a 2D coordinates (u,v) has a value that is formed by coordinates (x, y, z) of a vertex in the 3D domain. In an example, a texture atlas includes color information of the 3D mesh. For example, a point in the texture atlas at the 2D coordinates (u,v) (which has a 3D value of (x,y,z) in the UV atlas) has a color that specifies the color attribute of a point at (x, y, z) in the 3D domain. In some examples, the coordinates (x, y, z) in the 3D domain are referred to as 3D coordinates, or xyz coordinates, and the 2D coordinates (u,v) are referred to as uv coordinates or UV coordinates. In an example, a position of a vertex (e.g., the vertex (611)) in a mesh such as the polygon mesh (600) is indicated by the 3D coordinate (x, y, z), the vertex may correspond to a 2D point in a 2D map or the UV map (e.g., the vertex may be mapped to the 2D point in the UV map), and a position of the 2D point may be indicated by the UV coordinate (u, v).

Mesh compression may include connectivity and/or topology coding and attribute value coding (e.g., value coding for each attribute).

Various methods may be used to code (e.g., encode and/or decode) connectivity of a mesh (e.g., a polygon mesh). In some examples, a dual-degree based method (also referred to as a dual degree traversal mode) and a polygon-fan based method (also referred to as a polygon fan traversal mode) may be used to code connectivity of a polygon mesh, for example, by traversing the polygon mesh and coding the connectivity around each pivot vertex during the traversal.

In an aspect, the dual-degree based method may code connectivity of a polygon mesh with arbitrary face degrees or arbitrary vertex degrees. The dual-degree based method may use the duality between a primal mesh and a dual mesh to code the connectivity by generating two sequences of symbols, the vertex degrees and face degrees. FIG. 7 shows an example of a primal mesh (701) and a dual mesh (702) according to an aspect of the disclosure. The dual mesh (702) may be built by a dualization process (703), for example, by placing one node in each original face in the primal mesh (701) and connecting the nodes through each edge incident to two original faces in the primal mesh (701). In an aspect, an original face in the primal mesh (701) having a face degree of NI corresponds to a vertex in the dual mesh (702) having a vertex degree of NI where the vertex is the node inside the original face. Referring to FIG. 7, an original face (711) in the primal mesh (701) having a face degree of 3 corresponds to a vertex (721) in the dual mesh (702) having a vertex degree of 3. Referring to FIG. 7, an original face (712) in the primal mesh (701) having a face degree of 5 corresponds to a vertex (722) in the dual mesh (702) having a vertex degree of 5.

The dual-degree based method may encode the two sequences of symbols separately. In an example, the dual-degree based method uses a sequence of vertex degrees and a sequence of face degrees. In some examples, coding performance of the dual-degree based method depends highly on a mesh regularity. A mesh regularity may indicate (e.g., measure) a variance of the vertex degrees of the polygon mesh and/or a variance of face degrees of the polygon mesh. In an aspect, the less of the variance of the vertex degrees, the more regular the polygon mesh, and the higher the connectivity coding efficiency. In an aspect, the less of the variance of the face degrees, the more regular the polygon mesh, and the higher the connectivity coding efficiency. In some related technologies, the dual-degree based method is near-optimal for worst-case meshes, where the entropy of the two sequences of symbols may achieve Tutte entropy bound for planar graphs of 2 bits per edge.

In an aspect, vertex and face data structures may be maintained explicitly. For a vertex, a vertex degree (VD) and references to all incident faces in an order (e.g., a counterclockwise order) may be stored in a data structure associated with the vertex. For a face, a face degree (FD) and references to all incident vertices in an order (e.g., a counterclockwise order) may be stored. Vertices and faces may go through a sequence of states such as an empty state, an active state, and a complete state. In an example, at a given time at most one face is active, and multiple vertices may be active. In an example, the multiple active vertices may be held in an active vertex queue. When a face is processed, for example, moved from an empty state (e.g., when the face is not processed), to an active state (e.g., when the face is being processed), and then to a complete state (e.g., when the face is processed), all vertices of the face that are not yet active may be activated through insertion into the active vertex queue. Consequently, each active vertex has at least one complete incident face. When none of faces incident to a vertex is processed, the vertex is not an active vertex and is in an empty state. The vertex is not visited. When all the faces incident to a vertex have become complete (e.g., all the faces are processed), the vertex changes its state to complete (e.g., the vertex is processed) and may be removed from the active vertex queue.

In some examples, the active vertex queue is an active vertex priority queue where an active index having the highest priority is traversed prior to other active indices in the active vertex queue. For example, the active index having the highest priority is made the current vertex such as the pivot vertex, and is processed and then removed from the active vertex queue. In an example, the active vertex queue represents a boundary between a part of the polygon mesh which has already been traversed and a part of the polygon mesh as yet to be visited.

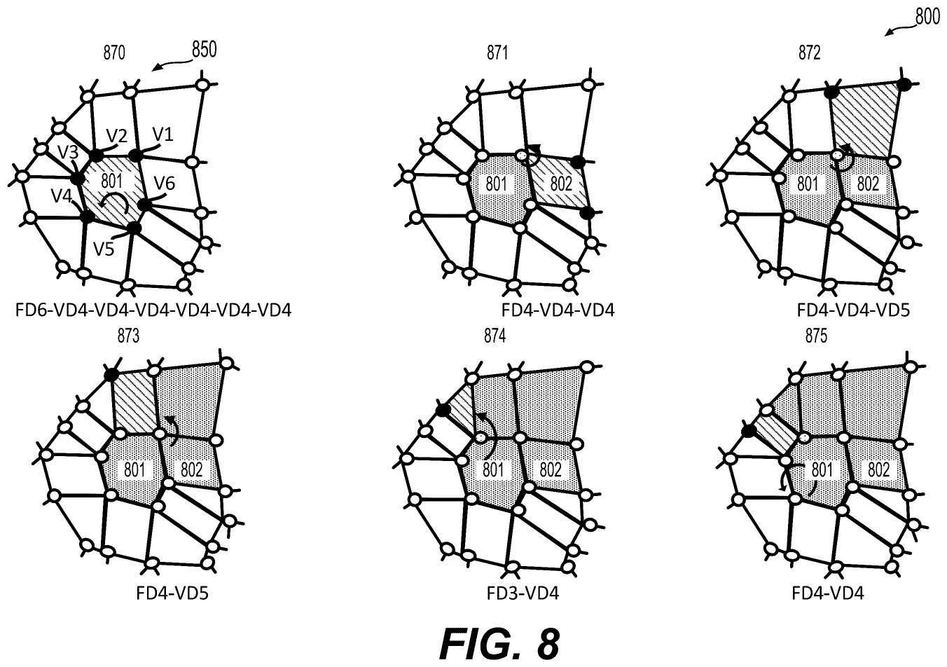

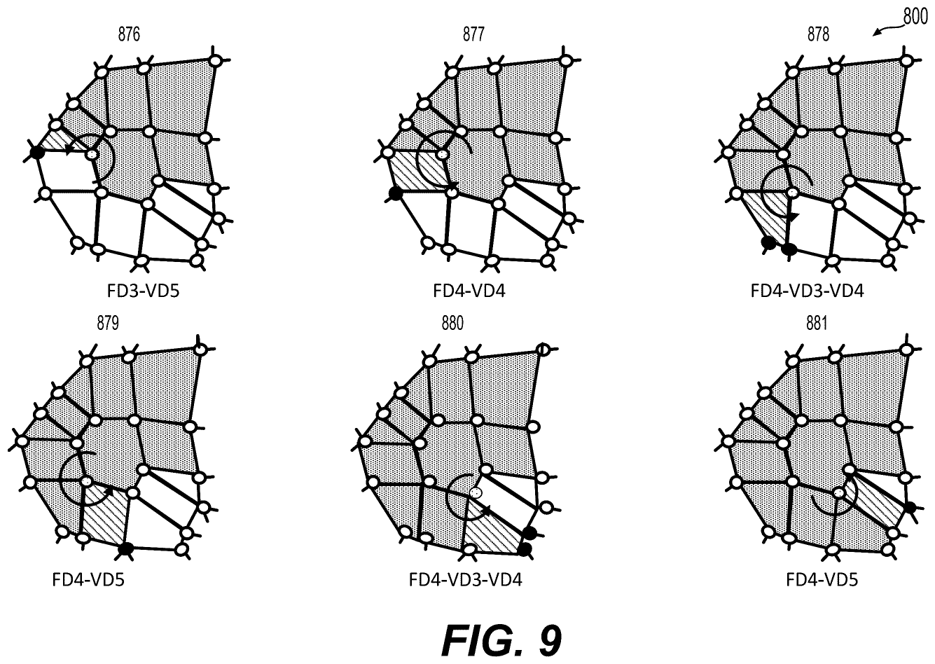

FIGS. 8-9 show an example of a traversal sequence (800) of the dual-degree algorithm according to an aspect of the disclosure. In an example, the traversal sequence (800) may start from a seed face (801) of a polygon mesh (850). At the beginning (e.g., at a step (870)), a seed face degree (FD) (e.g., 6 as indicated by FD6) may be output along with vertex degrees of all vertices of the seed face (801). In the example shown in FIG. 8, the seed face (801) has 6 vertices V1-V6, each of the vertices has a vertex degree (VD) of 4 as indicated by VD4.

At a step (871), a first vertex (e.g., V1) of the seed face (801) may become active and a next face (802) may be traversed, for example, in a counterclockwise order, resulting in one face degree and two vertex valences output, such as FD4, VD4, and VD4.

The traversal keeps going until all the faces and vertices in the polygon mesh (850) have been visited.

In an example, the seed face (801) is chosen and all neighbors of the seed face (801) are traversed recursively until all faces of the corresponding connected component are visited. Referring to FIGS. 8-9, a subset of all neighbors of the seed face (801) is traversed in the steps (872)-(881). A new seed face of the next connected component is then chosen and the traversal sequence (800) may continue. Every time the encoder traverses the next element of the polygon mesh (850), the encoder may output some symbol which uniquely identifies a new state. From this stream of symbols, the decoder can reconstruct the polygon mesh (850). In an example, two sets of symbols may be used to encode vertex degrees and face degrees. At a given moment, the encoder and the decoder may know which type of symbol (face or vertex) is being dealt with.

In an aspect, the mesh traversal such as the traversal sequence (800) may be started by selecting the seed face (801). The encoder outputs the face degree of the seed face (801), followed by the vertex degrees of all the vertices V1-V6 incident to the seed face (801), e.g., in a counterclockwise order such as FD6-VD4-VD4-VD4-VD4-VD4-VD4 in the step (870). The vertices (e.g., the 6 vertices V1-V6) may be added to the active vertex queue. The decoder may receive the seed face degree (e.g., FD6) and creates a corresponding face. The decoder may fill all the slots for the incident vertices, moving the incident vertices from the empty to active state, e.g., enters the incident vertices into an active vertex queue of the decoder. Thus, the encoder and the decoder may maintain matching states.

The traversal such as the traversal sequence (800) may continue by removing the highest priority active vertex from the active vertex queue and making it the current vertex. The algorithm proceeds, for example, counterclockwise around the active vertex, skipping all faces which have already been completed. In an example, for an active vertex, at least one face is completed and at least one incident face is still empty, otherwise the vertex may not be in the active vertex queue.

When the encoder detects an empty face, such as an empty slot in the incident face data structure associated with the current vertex, the encoder may proceed through the following steps: (i) the face is activated and becomes the “current” face, and a face degree of the current face is output; (ii) the current face is added to an appropriate slot in the incident face data structures associated with the current vertex as well as any other active vertices which are incident to current face; (iii) any remaining empty vertices of the current face are activated and the respective vertex degrees output in an order, for example, in a counterclockwise order; and (iv) the current face is complete and removed from processing.

In an aspect, referring to FIGS. 8-9, the active vertex and the subsequently selected active face may be considered as successive pivots, and may be referred to as a pivot vertex and a current face, respectively.

The decoder may use a symmetric procedure, ensuring the same traversal as the encoder. When the decoder finds the first empty face slot in the currently active vertex, the decoder may proceed as follows: (i) read in a face degree and create the face, moving the face from state “empty” to “active,” calling the face the “current” face; (ii) add the current face to the appropriate slot in the active vertex and any other active vertices the current face is incident on; (iii) read the vertex degrees of the remaining empty vertices incident on the current face, activating the remaining empty vertices incident on the current face through insertion into the active vertex queue; (iv) move the current face to the complete state.

In an example, vertices completed during the traversal of the current face are removed from the active vertex queue. The vertices completed during the traversal of the current face no further belong to the boundary of the traversed region. After the current face is processed, the algorithm proceeds to the next face in the currently active vertex until the currently active vertex is complete. Subsequently a new active vertex is taken from the queue and the process repeats until the active vertex queue is empty. If there are some connected components remaining, a new seed face is chosen on it and another component traversal starts.

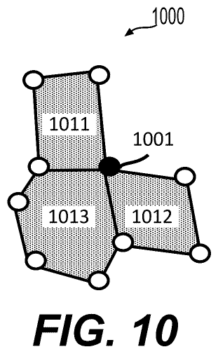

In an aspect, vertices of a polygon mesh may be traversed by an encoder, for example, according to a deterministic order reproducible at a decoder side. In an example, in each step, faces incident to a current vertex may be decomposed into a set of polygon-fans sharing the current vertex as a pivot, such as shown in FIG. 10. FIG. 10 shows an example of a polygon-fan (1000) according to an aspect of the disclosure. The polygon-fan (1000) includes three incident faces (1011)-(1013) that share a pivot (or a pivot vertex) (1001). In an aspect, all faces in a polygon-fan are incident to a pivot vertex, and the polygon-fan includes consecutive faces. Two of the consecutive faces may share an edge.

In an example, connectivity and geometry of polygon-fans are coded (e.g., encoded and/or decoded) in an interleaved manner. For each polygon-fan, connectivity information of the respective polygon-fan is coded.

Various vertex traversal methods may be used. The vertex traversal methods may include valence-based traversal, geometry-based traversal, and the like. The valence-based traversal and the geometry-based traversal may keep track of a list of active vertices, which correspond to vertices to be visited and compressed next. The vertices in the list may be stored in a priority queue such as an active vertex priority queue described in the disclosure and visited according to the priority (e.g., vertices with the highest priority are visited first). The valence-based traversal and the geometry-based traversal may define two different priority measures. In an example, the valence-based traversal exploits the connectivity information and measures the priority of an active vertex by counting a number of already encoded polygons (e.g., triangles) incident to the active vertex. The geometry-based traversal may exploit both the connectivity and geometry information. The geometry-based traversal may measure the priority of an active vertex by computing conquered valence, for example, defined as a sum of angles (e.g., diamond angles) of already encoded polygons (e.g., triangles) incident to it.

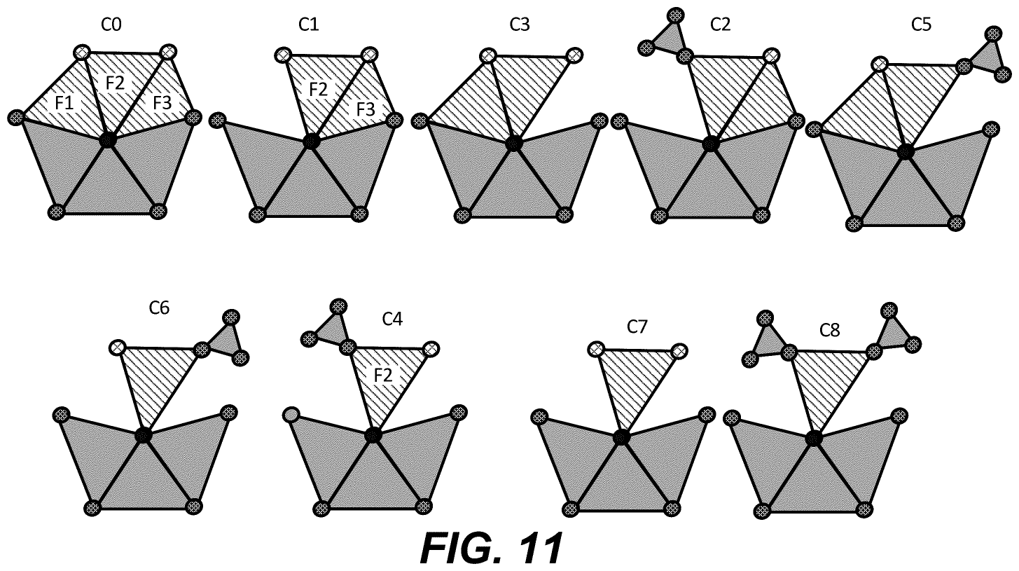

In some examples, a polygon-fan is triangulated and a number of triangles for each face may be compressed by using the context adaptive binary arithmetic. In an example, the connectivity of the obtained triangle-fans is compressed by using nine topological configurations C0-C8 shown in FIG. 11. FIG. 11 shows an example of topological configurations C0-C8 used to compress a triangle-fan connectivity according to an aspect of the disclosure. Referring to FIG. 11, a polygon-fan of each topological configuration includes hatched face(s). For example, the polygon-fan of C0 includes 3 hatched face(s) F1-F3, the polygon-fan of Cl includes 2 hatched face(s) F2-F3, and the polygon-fan of C4 includes 1 hatched face.

In an aspect, the polygon-fan method may be used to code (e.g., encode and/or decode) connectivity of a polygon mesh. To code the connectivity at a pivot vertex, the polygon-fan method may determine polygon-fans. For each polygon-fan, a number of faces and a face degree of each face may be coded using an entropy coding method. In some examples, a polygon-fan may be triangulated, resulting in a triangle-fan, whose connectivity is coded (e.g., encoded and/or decoded) using a plurality of topological configurations shown in FIG. 11.

In some examples, the attributes include one or more of positions, texture coordinates, normal, and the like. A predictive coding scheme is used to code (e.g., encode and/or decode) the attribute values where a residue between an original attribute value and a predicted attribute value is entropy coded. In an aspect, a set of candidate predictors may be available, and a predictor index (e.g., an optimal predictor index) may be signaled alongside.

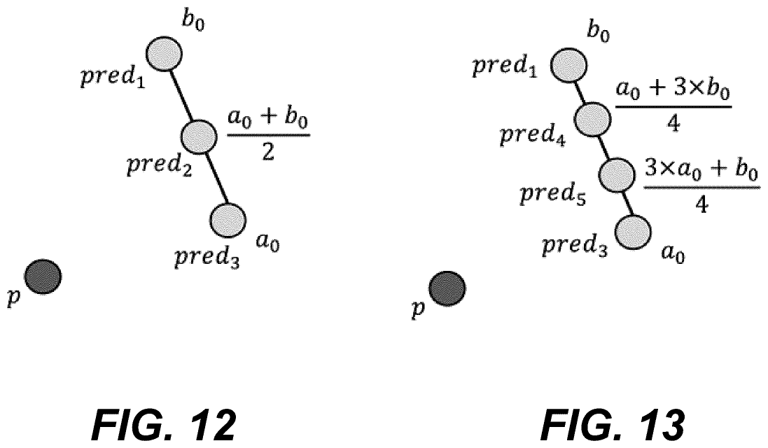

FIGS. 12-13 show examples of predicting an attribute that is associated with a vertex p in a mesh using two references a₀ and b₀. Referring to FIG. 12, 3 predictors [pred₂, pred₁, pred₃] are used. In an example, pred₁ is b₀, pred₂ is (a₀+b₀)/2, and pred₃ is a₀. Referring to FIG. 13, 4 predictors [pred₁, pred₄, pred₅, pred₃] are used. In an example, pred₁ is b₀, pred₄ is (a₀+3b₀)/4, pred₅ is (3a₀+b₀)/4, and pred₃ is a₀. The attribute associated with the vertex p is predicted based on a predictor from a list of candidate predictors [pred₁, pred₂, . . . , pred_{N}]. In an example, the predictor is indicated by a predictor index.

A lossless mesh coding format such as Draco may be used, for example, for 2-manifold meshes. In an example, an edge is only shared by at most two faces in a 2-manifold mesh. Static polygonal meshes may be coded using lossless and lossy coding. For example, VVM (Versatile Video Coding for Meshes) is an ongoing mesh coding standard for both lossless and lossy compression of static polygonal meshes.

In an example, to code the values of the position and UV attributes, prediction schemes may be utilized. For example, the value of each position of mesh vertices in a mesh (e.g., a 3D mesh) or UV coordinates may be predicted by using a fixed value (e.g., zeros or centroids), a value of a previous position or a previous UV coordinate, an average of last n positions or an average of last n UV coordinates, parallelogram prediction(s), reflection prediction(s), and/or the like.

In an aspect, the points may be 2D points in a 2D map where the 2D map is associated with a mesh such as a 3D mesh. For example, the 2D map may be determined based on the 3D mesh. Positions of the 2D points may be indicated by 2D coordinates such as UV coordinates. For purposes of brevity, the descriptions in some examples are given using vertices in a mesh, and the descriptions may be suitably adapted for 2D points in a 2D map to predict the positions of the 2D points.

Concurrently encoding connected components of a mesh (e.g., a polygon mesh) which share the same connectivity is described. In an example, an input mesh is examined and connected components with the same connectivity are grouped together. Then, for each group of connected components, the respective shared connectivity is coded followed by coding values of attributes (e.g., all the attributes) within the respective group. In an example, a prediction refinement scheme is used where a residue of an already coded (e.g., encoded) attribute improves a prediction of a corresponding attribute in another connected component within the same group.

In an aspect, mesh coding includes connectivity coding and attribute value coding. In an example, a connectivity describes how vertices in the mesh are connected. Connectivity coding includes coding (e.g., encoding and/or decoding) the incidence relationships among attributes that are traversed based on a traversal algorithm.

In some examples, meshes, such as meshes including digitally created contents (DCC), include repeated connected components. In related technologies, mesh coding algorithms and standards may not fully exploit the fact that multiple meshes may share the same connectivity. In related technologies, prediction of attributes in mesh coding methods is, for example, restricted to prediction from already encoded attributes in the local neighborhood within the same connected component. However, for repeated connected components (e.g., repeated connected components in the same mesh) which are related by a rigid transformation, when attribute values in a first connected component are encoded, they may be used to predict attributes in subsequent repeated connected components.

In an aspect, a group of connected components includes a set of connected components which share the same connectivity. In an example, the group of connected components is defined as the set of connected components which share the same connectivity. In an aspect, the group of connected components have the same connectivity. In an example, a group of connected components includes one or more connected components. A mesh with N connected components may have M groups where MEN. When M is equal to N, each group includes one connected component.

In an example, two connected components with the same connectivity are part of two different groups. This may be due to the inability of an algorithm to detect the same connectivity between the connected components and/or for optimizing some other criteria.

Methods in the disclosure may be applied to any geometry coding and/or attribute encoding for arbitrary polygon meshes and irrespective of the traversal algorithm used. The methods may be applied to arbitrary polygon meshes. The methods may be used separately or in combination of any forms.

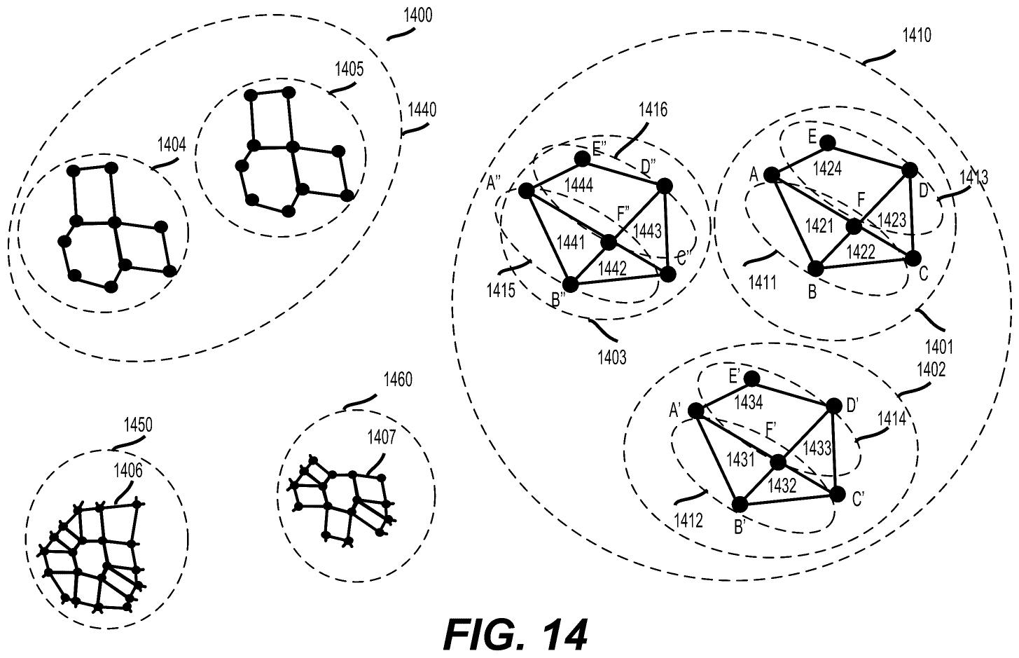

In an aspect, referring to FIG. 14, a mesh (1400) such as a 3D mesh includes a first group (1410) of connected components that has a first connectivity. For example, the first group (1410) includes connected components (1401)-(1403) that share the first connectivity. In an example, each pair of the connected components (1401)-(1403) is related by a rigid transformation, such as a translation of the connected component (1402) with respect to the connected component (1401). In some examples, a rigid transformation maintains the same shape, and includes one or more of a rotation, a translation, a reflection (e.g., a reflection about a plane), and the like.

In an example, the connected component (1401) includes vertices A-F and faces (1421)-(1424), and a connectivity of the connected component (1401) indicates, for example, the connectivity associated with the vertices A-F and/or the faces (1421)-(1424). In an example, the connected component (1402) includes vertices A′-F′ and faces (1431)-(1434), and a connectivity of the connected component (1402) indicates the connectivity associated with the vertices A′-F′ and/or the faces (1431)-(1434). In an example, the connected component (1403) includes vertices A″-F″ and faces (1441)-(1444), and a connectivity of the connected component (1403) indicates the connectivity associated with the vertices A″-F″ and/or the faces (1441)-(1444).

In an example, the vertices A′-F′ are related to the vertices A-F by a rigid transformation (e.g., the vertices A′-F′ are related to the vertices A-F by a translation), and the connectivity of the connected component (1401) and the connectivity of the connected component (1402) are the same and are referred to as the first connectivity. Similarly, the connectivity of the connected component (1403) is also referred to as the first connectivity. In an example, the first connectivity indicates how the vertices (e.g., A-F, A′-F′, or A″-F″) are connected.

At least one portion of the first connectivity is determined. The at least one portion of the first connectivity is shared by at least one region of each connected component in the first group (1410). For example, a region (1411) of the connected component (1401), a region (1412) of the connected component (1402), and a region (1415) of the connected component (1403) share a portion of the first connectivity where the portion indicates the connectivity associated with the vertices such as (i) A-C and F, (ii) A′-C′ and F′, or (iii) A″-C″ and F″. The region (1411) includes the faces (1421)-(1422) and the vertices A-C and F. The region (1412) includes the faces (1431)-(1432) and the vertices A′-C′ and F′. The region (1411) and the region (1412) are related by the translation. The portion indicates the connectivity associated with the vertices (e.g., (i) A-C and F, (ii) A′-C′ and F′, or (iii) A″-C″ and F″) is determined. In an example, the portion is only determined one time for the regions (1411)-(1412) and (1415) as the portion is shared by the regions (1411)-(1412) and (1415).

For each connected component in the first group (1410), attribute values of vertices in the at least one region of the respective connected component are determined. In an example, for the connected component (1401), the attribute values of the vertices A-C and Fin the region (1411) of the connected component (1401) are determined. In an example, for the connected component (1402), the attribute values of the vertices A′-C′ and F′ in the region (1412) of the connected component (1402) are determined. In an example, for the connected component (1403), the attribute values of the vertices A″-C″ and F″ in the region (1415) of the connected component (1403) are determined.

In an aspect, one or more groups of connected components are encoded where each group has the same connectivity, for example, the group shares the same connectivity.

In an aspect, a mesh coding method uses interleaved coding of connectivity and attribute values. The at least one portion of the first connectivity is a first one of a plurality of portions of the first connectivity. Referring to FIG. 14, the plurality of portions of the first connectivity includes (a) the portion indicating the connectivity associated with the vertices A-C and F (or (i) the vertices A′-C′ and F′ or (ii) the vertices A″-C″ and F″) and (b) a portion indicating the connectivity associated with the vertices A and C-F (or (i) the vertices A′ and C′-F′ or (ii) the vertices A″ and C″-F″). The first one of the plurality of portions is the portion indicating the connectivity of the vertices A-C and F (or (i) the vertices A′-C′ and F′ or (ii) the vertices A″-C″ and F″).

The at least one region of the respective connected component is a first region of the respective connected component. Referring to FIG. 14, the first region of the connected component (1401) is the region (1411). The first region of the connected component (1402) is the region (1412). The first region of the connected component (1403) is the region (1415). A number of the connected components in the first group (1410) is determined. Referring to FIG. 14, the number of the connected components (1401)-(1403) in the first group (1410) is determined to be 3.

After determining the first one of the plurality of portions of the first connectivity and determining, for each connected component in the first group, the attribute values of the vertices in the first region of the respective connected component, a second portion of the plurality of portions of the first connectivity is determined. The second portion of the plurality of portions of the first connectivity is shared by second regions of the respective connected components in the first group. For each connected component in the first group, attribute values of vertices in the second region of the respective connected component are determined. Referring to FIG. 14, after (i) determining the first one (e.g., the portion indicating the connectivity of the vertices A-C and F (or (i) A′-C′ and F or (ii) A″-C″ and F″)) of the plurality of portions of the first connectivity and (ii) determining the attribute values of the vertices in the respective first regions (1411)-(1412) and (1415), the second portion of the plurality of portions of the first connectivity is determined. The second portion is the portion indicating the connectivity of the vertices A and C-F (or (i) the vertices A′ and C′-F′ or (ii) the vertices A″ and C″-F″). The second portion is shared by second regions (1413)-(1414) and (1416) of the respective connected components (1401)-(1403) in the first group (1410). For the connected component (1401), attribute values of vertices in the second region (1413) of the connected component (1401) are determined. For the connected component (1402), attribute values of vertices in the second region (1414) of the connected component (1402) are determined. For the connected component (1403), attribute values of vertices in the second region (1416) of the connected component (1403) are determined.

As described above, in some examples, the mesh coding method follows the interleaved coding of connectivity and attribute values, where the connectivity of a region (e.g., the region (1411)) is coded (e.g., a polygon fan) followed by coding associated attribute values (e.g., polygon fan vertices) followed by coding the connectivity of the next region (e.g., (1413)) and the like. In an aspect, the above steps of interleaved coding are adapted to a general form as follows where k regions are of the connected component and are coded in an interleaved manner.

For each group
1. Encode the number (e.g., 3) of connected components in the group (e.g., the first group (1410));
2. Encode the shared connectivity of the region 1 (e.g., the first portion indicating connectivity of the vertices A-C and F (or (i) A′-C′ and F′ or (ii) A″-C″ and F″));
3. For each connected component (e.g., (1401), (1402), or (1403)) in the group,
   Encode predictor indices of the region 1 (e.g., (1411) if for the connected component (1401), (1412) if for the connected component (1402), or (1415) if for the connected component (1403));
   Encode attribute values of the region 1 (e.g., (1411) if for the connected component (1401), (1412) if for the connected component (1402), or (1415) if for the connected component (1403));
4. Encode the shared connectivity of the region 2 (e.g., the second portion indicating connectivity of the vertices A and C-F (or (i) the vertices A′ and C′-F′ or (ii) or the vertices A″ and C″-F″));
5. For each connected component (e.g., (1401), (1402), or (1403)) in the group
   Encode predictor indices of the region 2 (e.g., (1413) if for the connected component (1401), (1414) if for the connected component (1402), or (1416) if for the connected component (1403));
   Encode attribute values of the region 2 (e.g., (1413) if for the connected component (1401), (1414) if for the connected component (1402), or (1416) if for the connected component (1403));
6. Encode the shared connectivity of the region k;
7. For each connected component in the group;
   Encode predictor indices of the region k;
   Encode attribute values of the region k.

In the interleaved coding described above, the shared connectivity of the first portion is only encoded one time (instead of being encoded three times for the first regions (1411)-(1412) and (1415), respectively), and thus improving coding efficiencies, and the predictor indices and the attribute values of the respective first regions are encoded for the first regions (1411)-(1412) and (1415), respectively.

In an aspect, each group has the same connectivity. Instead of using the interleaved coding method, the entire connectivity is coded. For example, the at least one portion of the first connectivity is the first connectivity. For each connected component in the first group (1410), the at least one region of the respective connected component is the respective connected component, and a number (e.g., 3) of the connected components in the first group (1410) is determined. For each connected component in the first group (1410), predictor indices for the respective attribute values of the vertices in the respective connected component are determined and the attribute values of the vertices in the respective connected component are determined based on the respective predictor indices. The steps are as follows.

For each group
1. Encode the number (e.g., 3) of connected components in the group (e.g., the first group (1410));
2. Encode the shared connectivity of the group (e.g., encode the first connectivity of the first group (1410) where the first connectivity indicating the connectivity associated with the vertices A-F, A′-F′, or A″-F″); and
3. For each connected component in the group
   Encode predictor indices of the connected component (e.g., (1401), (1402), or (1403)); and
   Encode attribute values of the connected component (e.g., (1401), (1402), or (1403)).

In the coding described above, the shared connectivity of the first group (1410) is only encoded one time (instead of being encoded three times for the connected components (1401)-(1403), respectively), and thus improving coding efficiencies.

In an aspect, the mesh (1400) includes a plurality of groups (1410), (1440), (1450), and (1460) of connected components. Connected component(s) of each group of connected components share a respective connectivity. The plurality of groups (1410), (1440), (1450), and (1460) includes a first subset of groups and a second subset of groups. The first subset of groups includes the first group (1410). In the example shown in FIG. 14, the first subset of groups also includes the group (1440). Each of the first subset of groups has more than one connected component. For example, the first group (1410) includes three connected components (1401)-(1403). The group (1440) includes two connected components (1404)-(1405). Each of the second subset of groups has only one connected component. For example, the group (1450) includes only one connected component (1406), and the group (1460) includes only one connected component (1407).

The plurality of groups (1410), (1440), (1450), and (1460) are sorted based on numbers of connected components in the respective groups. The second subset of groups including (1450) and (1460) is decoded after decoding the first subset of groups including (1410) and (1440). The number (e.g., 3) of the connected components in the first group (1410) is the largest among the numbers of connected components in the respective groups. For example, the numbers of connected components in the respective groups (1410), (1440), (1450), and (1460) are 3, 2, 1, and 1. For each group that is different from the first group (1410), a number of connected components of the respective group is determined when a number of connected components of a coded (e.g., decoded or encoded) group (e.g., a group that is previously decoded or encoded) is larger than 1. The connectivity of the respective group is determined. For each connected component in the respective group, attribute values of vertices in the respective connected component are determined.

In an example, the groups (1410), (1440), (1450), and (1460) are sorted such that all the groups with more than one connected component (e.g., the groups (1410) and (1440)) are encoded first. After that, all the groups with only one connected component per group (e.g., the groups (1450) and (1460)) are encoded. In an example, given this group sorting scheme, the number of connected components in the group only needs to be encoded for the group with more than one connected component and one time when a group (e.g., (1450) or (1460)) with one connected component is first encoded. After that, for the remaining groups (with one connected component), additional signaling is saved (e.g., no need to signal the numbers of connected component in the remaining groups where the number of connected component in each remaining group is 1.) Referring to FIG. 14, for the groups (1410), (1440), (1450), and (1460), the number (e.g., 3) of connected components for the group (1410), the number (e.g., 2) of connected components for the group (1440), and the number (e.g., 1) of connected components for the group (1450) are encoded. The number (e.g., 1) of connected components for the group (1460) is not encoded and is not signaled. The steps are as follows.
1. Sort the groups (e.g., the groups (1410), (1440), (1450), and (1460)) such that groups (e.g., the groups (1410), (1440)) with more than one connected component are encoded first;
2. For each group,
   If (i) the number of connected components in the group >1 or (ii) a first occurrence such that a number of connected components in the group is 1 (e.g., the group is the first group to be encoded with only 1 connected component), encode the number of connected components in the group;
   Encode the shared connectivity of the group; and
   For each connected component in the group,
      Encode predictor indices of the connected component; and
      Encode attribute values of the connected component.

In an aspect, the mesh (1400) includes the plurality of groups (1410), (1440), (1450), and (1460) of connected components. Each group of connected components shares the respective connectivity. The plurality of groups includes the first group (1410). The plurality of groups is sorted based on numbers of connected components in the respective groups. The number of the connected components in the first group (1410) is the largest among the numbers of connected components in the respective groups, as described above. For each group (e.g., (1440)) that is different from the first group (1410), a current number of connected components of the respective group (e.g., (1440)) is determined based on a previous number of connected components of a previously coded (e.g., decoded or encoded) group and a difference between the current number and the previous number. In an example, the previously decoded group is the first group (1410), the previous number of connected components of the previously decoded group (1410) is 3. The difference between the current number and the previous number (e.g., 3) is 1. The current number of connected components of the group (e.g., (1440)) is 2 (e.g., 3-1). The connectivity of the respective group (e.g., (1440)) is determined, for example, the connectivity of the connected component (1404) is determined. For each connected component in the respective group (e.g., (1440)), attribute values of vertices in the respective connected component (e.g., (1404) or (1405)) are determined.

In an example, groups such as the groups (1410), (1440), (1450), and (1460) are sorted in a decreasing order of the numbers of connected components of the respective groups and the groups are encoded in the decreasing order. Given this group sorting scheme, the number of connected components is encoded only for the first group (1410). For subsequent groups (e.g., (1440), (1450), and (1460)), the residue (or the difference) between the number of connected components in the previous group and the number of the connected components in the current group is encoded. The steps are as follows.
1. Sort the groups in the decreasing order of the numbers of connected components in the group;
2. For each group
   If the group is the first group to be encoded,
      encode the number of connected components in the group;
   Else
      encode the difference between the numbers of connected components in the previous group and the current group;
   Encode the shared connectivity of the group; and
   For each connected component in the group, encode predictor indices and attribute values.

Similarly, the groups can be sorted in an increasing order of the numbers of connected components and the residue (or the difference) between the numbers of connected components in the current group and the previous group is encoded.

In an aspect, for a first connected component (e.g., (1401)) in the first group (1410), predictor indices for the respective attribute values of the vertices in the first connected component (e.g., (1401)) are determined. For each connected component (e.g., (1401), (1402), or (1403)) in the first group (1410), the attribute values of the vertices in the respective connected component are determined based on the predictor indices determined for the first connected component (e.g., (1401)). As described in this aspect, the predictor indices are determined (e.g., coded) only one time (e.g., the predictor indices are coded only for the first connected component (e.g., (1401), and are not coded for the connected components (1402)-(1403)). For example, the same predictors (e.g., as indicted by the predictor indices) are reused when encoding the corresponding attribute values within each group. Corresponding attributes within the respective group share similar local neighborhood structures, and thus in some examples using the same predictor indices for all these attributes is desirable. Accordingly, the predictor indices are only signaled when encoding attributes of the first connected component within each group. The attribute value encoding step is described as follows. For each group,
1. Encode the number (e.g., 3) of connected components in the group (e.g., (1410));
2. Encode the shared connectivity of the group (e.g., (1410)); and
3. For each connected component in the group,
   If the connected component is the first connected component (e.g., (1401)) in the group to be encoded, encode predictor indices; and
   Encode attribute values.

In an aspect, for a current connected component in the first group (1410), initial attribute values of the vertices in the current connected component are determined. The attribute values of the vertices in the current connected component are determined based on the initial attribute values and corresponding residues of a connected component that is coded (e.g., decoded or encoded) prior to coding (e.g., decoding or encoding) remaining connected components in the first group. The remaining connected components includes the current connected component.

In an example, a prediction refinement scheme is used to improve the prediction of corresponding attributes in a group of rigidly transformed connected components when the first connected component attributes are already coded (e.g., decoded or encoded). In an example, the group is the first group (1410). When two connected components are related by a rigid transformation, the prediction residue vectors of two corresponding attributes are also related by the same rigid transform if the same linear predictors are used. Accordingly, prediction modes corresponding to connected components related by the rigid transformation including one or more of orthogonal rotations, reflection(s) about YZ, XZ and XY planes, translation(s), and the like are supported. Further, a generalized prediction mode (e.g., a Mode 10 in Table 1) assuming a rigidity constraint is used along with a skip refinement (e.g., zero) predictor (e.g., a Mode 0 in Table 1). The prediction refinement step is as follows.

$${pred}_{c {c}_{k - updadted}} = {pred}_{{cc}_{k}} + {RefinementPredictor}_{mode} ( {residue}_{{cc}_{0}} ) \qquad Eq . ( 1 )$$

In Eq. (1), residue_{cc}_{₀} indicates the prediction residue of the corresponding encoded attribute of the first connected component (e.g., (1401)) within the group (e.g., (1410)). pred_{cc}_{ₖ} and pred_{cc}_{_{k-updated}} indicate the current predictions of an attribute in the k-th connected component (e.g., (1402)) within the group (e.g., (1410)) before and after the refinement, respectively. In an example, k>0.

The refinement prediction modes (RefinementPredictor_{mode}) are listed in Table 1 below.

TABLE 1

| Mode | Type | Refinement Predictor |
|---|---|---|
| 0 | Zero | pred_{cc}_{ₖ} += (0,0,0) |
| 1 | Self | pred_{cc}_{ₖ} += (residue_{cc}_{₀} [0], residue_{cc}_{₀} [1], residue_{cc}_{₀} [2]) |
| 2 | Rotation | pred_{cc}_{ₖ} += (residue_{cc}_{₀} [0], residue_{cc}_{₀} [2], residue_{cc}_{₀} [1]) |
| 3 | Rotation | pred_{cc}_{ₖ} += (residue_{cc}_{₀} [1], residue_{cc}_{₀} [0], residue_{cc}_{₀} [2]) |
| 4 | Rotation | pred_{cc}_{ₖ} += (residue_{cc}_{₀} [1], residue_{cc}_{₀} [2], residue_{cc}_{₀} [0]) |
| 5 | Rotation | pred_{cc}_{ₖ} += (residue_{cc}_{₀} [2], residue_{cc}_{₀} [1], residue_{cc}_{₀} [0]) |
| 6 | Rotation | pred_{cc}_{ₖ} += (residue_{cc}_{₀} [2], residue_{cc}_{₀} [0], residue_{cc}_{₀} [1]) |
| 7 | Reflection | pred_{cc}_{ₖ} += (−residue_{cc}_{₀} [0], residue_{cc}_{₀} [1], residue_{cc}_{₀} [2]) |
| 8 | Reflection | pred_{cc}_{ₖ} += (residue_{cc}_{₀} [0], −residue_{cc}_{₀} [1], residue_{cc}_{₀} [2]) |
| 9 | Reflection | pred_{cc}_{ₖ} += (residue_{cc}_{₀} [0], residue_{cc}_{₀} [1], −residue_{cc}_{₀} [2]) |
| 10 | Generalized | pred_{cc}_{ₖ} += GeneralizedPredictor |

In the example shown in Table 1, the residue_{cc}_{₀} is a 3D vector having three components residue_{cc}_{₀}[0], residue_{cc}_{₀}[1], and residue_{cc}_{₀}[2]. The refinement prediction mode is a mode corresponding to a mode number that is one of 0-10. When the mode number is 0, there is no refinement (or zero refinement) where the refinement is skipped. When the mode number is 1, the residue_{cc}_{₀} is added to pred_{cc}_{ₖ} to generate pred_{cc}_{_{k-updated}}. When the mode number is one of 2-9, a variation of the residue_{cc}_{₀} is added to pred ccx to generate pred_{cc}_{_{k-updated}}. When the mode number is 10, the generalized predictor is added to pred_{cc}_{ₖ} to generate pred_{cc}_{_{k-updated}}.

In some examples, the generalized predictor is used in scenarios when the two connected components within the group are related by arbitrary rotations (e.g., the arbitrary rotations are different from the modes with the mode numbers 2-6). In some examples, for a rigid transformation, the residues residue_{cc}_{₀} and residue_{cc}_{ₖ} are related as

$${‖ {residue}_{c {c}_{0}} ‖}^{2} = {‖ {residue}_{c {c}_{k}} ‖}^{2} \qquad Eq . ( 2 )$$

In some examples, this relation (Eq. (2)) may not hold true exactly, for example, due to effect of quantization. Eq. (2) may be a close approximation in some examples. Using this property in Eq. (2), the two components of residue_{cc}_{ₖ} (e.g., two of residue_{cc}_{₀}[0], residue_{cc}_{₀}[1], and residue_{cc}_{₀}[2]) for which the corresponding components of pred_{cc}_{ₖ} have the smallest magnitude are signaled. In an example, an order (e.g., a deterministic order) of encoding components is followed as described below.

$$if ( {pred}_{{cc}_{k}} [ 0 ] \geq {pred}_{{cc}_{k}} [ 1 ] \&\& {pred}_{{cc}_{k}} [ 0 ] \geq {pred}_{{cc}_{k}} [ 2 ] ) ,$$

$$then order = [ 1 , 2 , 0 ]$$

$$else if ( {pred}_{{cc}_{k}} [ 1 ] \geq {pred}_{{cc}_{k}} [ 2 ] ) , then order = [ 2 , 0 , 1 ]$$

$$else , order = [ 0 , 1 , 2 ] .$$

In an example, the residue between the absolute value of the remaining component of residue_{cc}_{ₖ} and its prediction derived by exploiting above relation of norms is signaled. In an example, the sign of the remaining component (a) is derived from the sign of the two signaled components and the sign of the three components of residue_{cc}_{₀} (if only rotations and translation transformation are considered) or (b) is signaled (if a reflection may be present).

In an example, residue_{cc}_{₀}=[3,4,5], residue_{cc}_{ₖ}=[6,3,2], pred_{cc}_{ₖ}=[100,80,40]. Then, the encoding order of components is [1,2,0]. Thus, 3 is encoded first, and is followed by encoding 2. Then the residue between an absolute value of 6 and the positive square root \sqrt{(3²+4²+5²)−(3²+2²)} is signaled.

In some examples, residue coding uses arithmetic coding, exponential Golomb coding, a combination of both, or the like. The above description and example consider attribute dimension to be 3 (e.g., a 3D vector). The above description and example may be suitably adapted when encoding texture coordinates of a dimension of 2, e.g., a 2D vector.

In an example, the skip (zero) predictor corresponding to the mode number of 0 is used (i) when the two connected components in the group are not related by a rigid transformation or (ii) when the quantization noise is high (e.g., the quantization noise is larger than a threshold) and the initial prediction pred ccx may be more reliable.

In some examples, the predictor mode (e.g., one of the modes 0 to 10 shown in Table 1) is determined for each connected component within the group with respect to the first connected component of the group. In an example, the predictor mode is signaled for all but the first connected component in each group. Referring to FIG. 14, for the first group (1410), the first connected component of the group is the connected component (1401). Two predictor modes are determined for the connected components (1402)-(1403), respectively, with respect to the connected component (1401). The two predictor modes for the connected components (1402)-(1403) are signaled.

In an aspect, for a current connected component in the first group (1410), initial attribute values of the vertices in the current connected component are determined. The attribute values of the vertices in the current connected component are determined based on the initial attribute values and corresponding residues of a connected component that is decoded (e.g., that is previously decoded) prior to decoding the current connected component in a decoding order.

In an example, an alternate prediction refinement step to the one shown in Table 1 is described below. In this alternative example,

$${pred}_{c {c}_{k - updadted}} = {pred}_{c {c}_{k}} + {RefinementPredictor}_{mode} ( {residue}_{c {c}_{k - 1}} ) \qquad Eq . ( 3 )$$

In Eq. (3), residue_{cc}_{ₖ₋₁} indicates the prediction residue of the corresponding encoded attribute of the (k−1)-th connected component (e.g., (1402)) within the group (e.g., (1410). pred_{cc}_{ₖ} and pred_{cc}_{_{k-updated}} indicate the current predictions of an attribute in the k-th connected component (e.g., (1403)) within the group (e.g., (1410)) before and after the refinement, respectively. In an example, k>0. The refinement prediction modes and the generalized predictor are updated in which residue_{cc}_{₀} in Eq. (1) is replaced with residue_{cc}_{ₖ₋₁} in Eq. (3). The refinement prediction modes and the generalized predictor in Eq. (3) are the same as described with reference to Table 1.

In an aspect, a signaling scheme is used to encode the repeated connected components. In an example, the coded information includes a flag indicating that the mesh (1400) includes at least one group, and each of the at least one group has two or more connected components that have a same connectivity. The at least one group includes the first group (1410). Referring to FIG. 14, the mesh (1400) includes the groups (1410), (1440), (1450), and (1460). The at least one group includes (1410) and (1440).

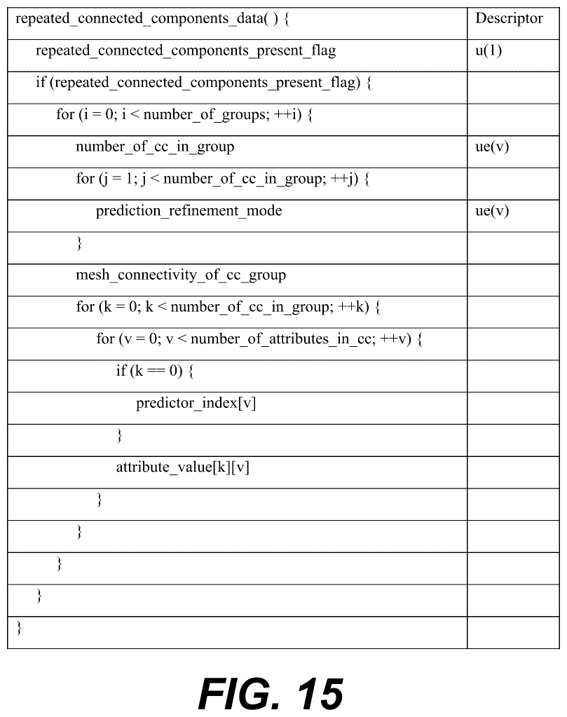

FIGS. 15-17 show an example of a signaling scheme according to an aspect of the disclosure. repeated_connected_components_present_flag equal to 1 specifies that the input mesh includes at least one group (e.g., (1410) or (1440) in FIG. 14) with two or more repeated connected components in it, where the two or more repeated connected components have the same connectivity. In this case, the coding tool is enabled.

repeated_connected_components_present_flag equal to 0 specifies that the input mesh does not include any group with two or more repeated connected components in it and the coding tool is disabled.

number_of_groups (e.g., a parameter) indicates the number of groups of connected components in the mesh determined during a mesh analysis. Referring to FIG. 14, the mesh (1400) includes the groups (1410), (1440), (1450), and (1460), and number_of_groups is 4.

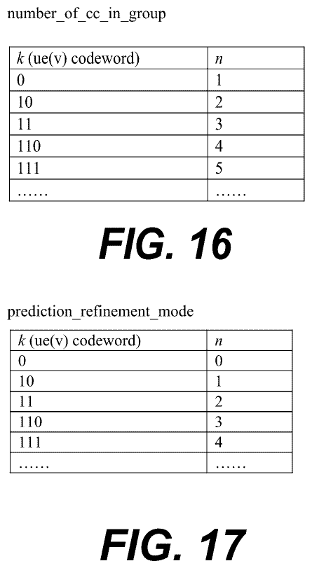

number_of_cc_in_group equal to k specifies the number of connected components in a group to be equal to n as described in FIG. 16. In an example, the binary 0/1 in the codewords shown in FIG. 16 may be flipped.

prediction_refinement_mode equal to k specifies the prediction refinement mode that are used in Eqs. (1) and (3) and described in Table I to be equal to n as described in FIG. 17. In an example, the binary 0/1 in the codewords shown in FIG. 17 may be flipped.

mesh_connectivity_of_cc_group is the shared mesh connectivity of the group encoded using any mesh connectivity coding methods. In an example, for the group (1410), the shared mesh connectivity is the first connectivity associated with the vertices A-F.

predictor_index is the index of the chosen predictor if multiple candidate predictors (e.g., [pred₁, pred₂, . . . , pred_{N}]) are available. In an example, predictor_index is encoded using a mesh coding method, such as any mesh coding method.

attribute_value is the attribute value such as a position, normal, or the like. In an example, attribute_value is encoded using a mesh coding method, such as any mesh coding method.

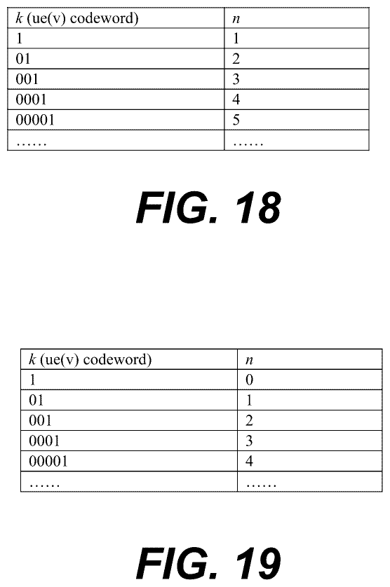

In an aspect, FIGS. 18-19 show an example of an alternate signaling scheme for number_of_cc_in_group and prediction_refinement_mode that is different from the signaling scheme shown in FIGS. 16-17. number_of_cc_in_group equal to k specifies the number of connected components in a group to be equal to n as described FIG. 18. In an example, the binary 0/1 in the codewords shown in FIG. 18 may be flipped. prediction_refinement_mode equal to k specifies the prediction refinement mode that are used in Eqs. (1) and (3) and described in Table 1 to be equal to n as described in FIG. 19. In an example, the binary 0/1 in the codewords shown in FIG. 19 may be flipped.

An adaptive traversal strategy for coding multiple connected components is described. An optimal mesh traversal strategy per connected component or per group of connected components may be adaptively determined and signaled. Signaling dominant modes in the dual degree traversal such as the vertex degree and the face degree per connected component or per group is disclosed.

Mesh coding includes connectivity coding and attribute value coding. Connectivity coding includes traversing the mesh vertices. Traversal strategies (also referred to as traversal algorithms) include the polygon fan traversal mode, the dual degree traversal mode, and the like. In an example, the encoder adaptively determines an optimal traversal algorithm, or a user specified traversal algorithm is used. In an example, when multiple traversal algorithms are supported, the traversal strategy used is signaled, for example, in a slice header.

Different mesh connected components may benefit from different traversals depending on characteristics of the respective meshes. In some examples, two connected components with the same traversal may have different characteristics leading to a different vertex degree and a face degree. In an example, a mesh includes different types of connected components such as triangular connected components and quadruple connected components. Different traversal modes may be more efficient for different types of connected components. In some examples, the polygon fan traversal mode is more efficient for the triangular connected components, and the dual degree traversal mode is more efficient for the quadruple connected components, and thus an adaptive traverse strategy is more efficient.

In an aspect, a vertex degree (e.g., a dominant vertex degree) per connected component and/or a face degree (e.g., a dominant face degree) per connected component are signaled if the connected component uses the dual degree traversal mode. In an example, a vertex degree (e.g., a dominant vertex degree) of a connected component is the most frequently occurring vertex degree of vertices in the connected component. In an example, a face degree (e.g., a dominant face degree) of a connected component is the most frequently occurring face degree of faces in the connected component. A signaling scheme is shown in Table 2.

TABLE 2

| | Descriptor |
|---|---|
| connected_components_data( ) { | |
| Slice header | |
| geo_traversal_mode | ue(v) |
| CC header | |
| if (geo_traversal_mode == 2) { | |
| cc_traversal | u(1) |
| if (cc_traversal == 1) { | |
| degree_face | ue(v) |
| degree_vertex | ue(v) |
| } | |
| } | |

In an example, referring to Table 2, geo_traversal_mode indicates whether one or more traversal strategies are used. geo_traversal_mode being equal to 0 indicates the polygon fan traversal only, geo_traversal_mode being equal to 1 indicates the dual degree traversal only, and geo_traversal_mode being equal to 2 indicates that every connected component has its own optimal traversal (e.g., the adaptive mode is used).

In an example, the coded information includes a first parameter (e.g., a first syntax element such as geo_traversal_mode) indicating whether a traversal mode for each of a plurality of connected components in the mesh (e.g., the mesh (1400)) is adaptive. In an example, the plurality of connected components does not include the connected components in the first group (1410). A first value (e.g., 0) of the first parameter indicates that the traversal mode for each of the plurality of connected components is the polygon fan traversal mode, a second value (e.g., 1) of the first parameter indicates that the traversal mode for each of the plurality of connected components is the dual degree traversal mode, and a third value (e.g., 2) of the first parameter indicates that the traversal mode for each of the plurality of connected components is adaptive, such as shown in Table 3. When a value of the first parameter (e.g., geo_traversal_mode) is the third value (e.g., 2) indicating that the traversal mode for each of the plurality of connected components is adaptive, the coded information includes a second parameter (e.g., a second syntax element such as cc_traversal) indicating the traversal mode for one of the plurality of connected components. In an example, the traversal mode is the polygon fan traversal mode or the dual degree traversal mode. When the second parameter (e.g., cc_traversal) indicates that the traversal mode is the dual degree traversal mode, the coded information includes a third parameter (e.g., a syntax element such as degree_face) indicating a face degree (e.g., a dominant face degree such as shown in Table 4) of the one of the plurality of connected components and a fourth parameter (e.g., a syntax element such as degree_vertex) indicating a vertex degree (e.g., a dominant vertex degree such as shown in Table 5) of the one of the plurality of connected components.

geo_traversal_mode being equal to k specifies whether the traversal is the polygon fan, the dual degree, or the adaptive as described in Table 3. The binary 0/1 in the codewords in Table 3 may be flipped.

TABLE 3

| k (ue(v) codeword) | geo_traversal_mode |
|---|---|
| 00 | 0 (Polygon Fan) |
| 01 | 1 (Dual Degree) |
| 10 | 2 (Adaptive) |

In an example, cc_traversal being equal to 0 specifies the polygon fan traversal mode. cc_traversal being equal to 1 specifies the dual degree traversal mode. degree_face being equal to k specifies the face degree (e.g., the dominant face degree) of the connected component to be equal to n as described in Table 4. Table 4 is an example of mapping between the codeword k and n. Other codewords may also be used to code n. The binary 0/1 in the codewords in Table 4 may be flipped.

TABLE 4

| k (ue(v) codeword) | n |
|---|---|
| 0 | 1 |
| 10 | 2 |
| 11 | 3 |
| 110 | 4 |
| 111 | 5 |
| . . . | . . . |

degree_vertex being equal to k specifies the vertex degree (e.g., the dominant vertex degree) of the connected component to be equal to n as described in Table 5. The binary 0/1 in the codewords in Table 5 may be flipped. Table 5 is an example of mapping between the codeword k and n. Other codewords may also be used to code n.

TABLE 5

| k (ue(v) codeword) | n |
|---|---|
| 0 | 1 |
| 10 | 2 |
| 11 | 3 |
| 110 | 4 |
| 111 | 5 |
| . . . | . . . |

In an aspect, connected components are grouped together as a group of connected components. The group of connected components includes a set of connected components which share the same traversal algorithm. In an example, connected components having a same connectivity have a same traversal algorithm. Connected components having a same traversal algorithm do not necessarily have a same connectivity. In an example, connected components having a same traversal algorithm have a same connectivity. In an example, connected components having a same traversal algorithm do not have a same connectivity.

In an example, a group size which is a number of connected components in the group of connected components which share the same traversal algorithm is signaled. If a traversal strategy of the group is the dual degree traversal mode, then the vertex degree and the face degree is only signaled once per group. In some examples, multiple connected components (e.g., two connected components) which share the same traversal algorithm may not necessarily be a part of the same group. Table 6 shows an example of a signaling scheme.

TABLE 6

| | Descriptor |
|---|---|
| connected_components_data( ) { | |
| Slice header | |
| geo_traversal_mode | ue(v) |
| Group CC header | |
| if (geo_traversal_mode == 2) { | |
| gcc_traversal | u(1) |
| num_cc_in_group | ACExpGolomb |
| if (gcc_traversal == 1) { | |
| degree_face | ue(v) |
| degree_vertex | ue(v) |
| } | |
| } | |

geo_traversal_mode indicates whether one or more traversal strategies are used. geo_traversal_mode being equal to 0 indicates the polygon fan traversal only, geo_traversal_mode being equal to 1 indicates the dual degree traversal only, and geo_traversal_mode being equal to 2 indicates every group of connected components has its own optimal traversal (e.g., the adaptive mode) where connected components in each group of connected components share the same traversal algorithm. geo_traversal_mode equal to k specifies whether the traversal is the polygon fan traversal, the dual degree traversal, or the adaptive mode as described in Table 3.

gcc_traversal equal to 0 specifies the polygon fan traversal for the group. gcc_traversal equal to 1 specifies the dual degree traversal for the group. num_cc_in_group is the number of connected components in the group signaled, for example, using a combination of arithmetic coding and exponential Golomb coding. degree_face equal to k specifies the face degree of the group to be equal to n as described in Table 4. degree_vertex equal to k specifies the vertex degree of the group to be equal to n as described in Table 5.

In an example, such as shown in Table 6 and referring to FIG. 14, the coded information includes the first syntax element such as geo_traversal_mode indicating whether a traversal mode for the first connectivity of the first group (1410) is adaptive. A first value of the first syntax element such as geo_traversal_mode indicating that the traversal mode for the first connectivity is the polygon fan traversal mode, a second value of the first syntax element indicating that the traversal mode for the first connectivity is the dual degree traversal mode, and a third value of the first syntax element indicating that the traversal mode for the first connectivity is adaptive. When a value of the first syntax element is the third value, the coded information includes a second syntax element (e.g., gcc_traversal) indicating the traversal mode for the first group (1410), and the traversal mode is the polygon fan traversal mode or the dual degree traversal mode. When the second syntax element indicates that the traversal mode is the dual degree traversal mode, the coded information includes a third syntax element (e.g., degree_face) indicating the face degree of the first group (1410) and a fourth syntax element (e.g., degree_vertex) indicating a vertex degree of the first group (1410).

In an aspect, connected components are grouped such that the connected components in the same group use the same traversal algorithm. If a group uses the dual degree traversal, then the dominant face degree and the dominant vertex degree are signaled for each connected component in the group, such as shown in Table 7. Table 7 shows an example of a signaling scheme.

TABLE 7

| | Descriptor |
|---|---|
| connected_components_data( ) { | |
| Slice header | |
| geo_traversal_mode | ue(v) |
| Group CC header | |
| if (geo_traversal_mode == 2) { | |
| gcc_traversal | u(1) |
| num_cc_in_group | ACExpGolomb |
| } | |
| CC header | |
| if (geo_traversal_mode == 2) { | |
| if (gcc_traversal == 1) { | |
| degree_face | ue(v) |
| degree_vertex | ue(v) |
| } | |
| } | |

geo_traversal_mode indicates whether one or more traversal strategies are used. geo_traversal_mode being equal to 0 indicates the polygon fan traversal only, geo_traversal_mode being equal to 1 indicates the dual degree traversal only and geo_traversal_mode being equal to 2 indicates that every group of connected components has its own optimal traversal (e.g., the adaptive mode is used). geo_traversal_mode equal to k specifies whether the traversal mode is the polygon fan traversal, the dual degree traversal, or the adaptive mode as described in Table 3. gcc_traversal equal to 0 specifies the polygon fan traversal for the group. gcc_traversal equal to 1 specifies the dual degree traversal for the group. num_cc_in_group is the number of connected components in the group signaled using a combination of arithmetic coding and exponential Golomb coding. degree_face equal to k specifies the face degree per connected component to be equal to n as described in Table 4. degree_vertex equal to k specifies the vertex degree per connected component to be equal to n as described in Table 5.

In an example, such as shown in Table 7 and referring to FIG. 14, the coded information includes the first syntax element such as geo_traversal_mode indicating whether the traversal mode for the first connectivity of the first group (1410) is adaptive. As shown in Table 3, the first value (e.g., 0) of the first syntax element indicating that the traversal mode for the first connectivity is the polygon fan traversal mode, the second value (e.g., 1) of the first syntax element indicating that the traversal mode for the first connectivity is the dual degree traversal mode, and the third value (e.g., 2) of the first syntax element indicating that the traversal mode for the first connectivity is adaptive. When a value of the first syntax element is the third value, the coded information includes the second syntax element (e.g., gcc_traversal) indicating the traversal mode for the first group (1410). The traversal mode is the polygon fan traversal mode or the dual degree traversal mode. When the second syntax element indicates that the traversal mode is the dual degree traversal mode, the coded information includes the third syntax element (e.g., degree_face) for each connected component in the first group (1410) indicating the face degree of the respective connected component and a fourth syntax element (e.g., degree_vertex) for the respective connected component indicating the vertex degree of the respective connected component.

In an aspect, a vertex degree mode is signaled once per group and a face degree mode is signaled per connected component as shown in Table 8. In an example, the vertex degree mode per group indicates the dominant vertex degree that is the most frequently occurred vertex degree in the group. In an example, the face degree mode per connected component indicates the dominant face degree that is the most frequently occurred face degree in the connected component. Table 8 shows an example of a signaling scheme.

TABLE 8

| | Descriptor |
|---|---|
| connected_components_data( ) { | |
| Slice header | |
| geo_traversal_mode | ue(v) |
| Group CC header | |
| if (geo_traversal_mode == 2) { | |
| gcc_traversal | u(1) |
| num_cc_in_group | ACExpGolomb |
| if (gcc_traversal == 1) { | |
| degree_vertex | ue(v) |
| } | |
| } | |
| CC header | |
| if (geo_traversal_mode == 2) { | |
| if (gcc_traversal == 1) { | |
| degree_face | ue(v) |
| } | |
| } | |

geo_traversal_mode indicates whether one or more traversal strategies are used. geo_traversal_mode being equal to 0 indicates the polygon fan traversal only, geo_traversal_mode being equal to 1 indicates the dual degree traversal only and geo_traversal_mode being equal to 2 indicates every connected component has its own optimal traversal (e.g., the adaptive mode is used). geo_traversal_mode equal to k specifies whether the traversal mode is the polygon fan traversal, the dual degree traversal, or the adaptive mode as described in Table 3. gcc_traversal equal to 0 specifies the polygon fan traversal for the group. gcc_traversal equal to 1 specifies the dual degree traversal for the group. num_cc_in_group is the number of connected components in the group signaled, for example, using a combination of arithmetic coding and exponential Golomb coding. degree_vertex equal to k specifies the vertex degree per group to be equal to n as described in Table 4. degree_face equal to k specifies the face degree per connected component in the group to be equal to n as described in Table 5.

In an example, such as shown in Table 8 and referring to FIG. 14, the coded information includes the first syntax element such as geo_traversal_mode indicating whether the traversal mode for the first connectivity of the first group (1410) is adaptive. As shown in Table 3, the first value (e.g., 0) of the first syntax element indicating that the traversal mode for the first connectivity is the polygon fan traversal mode, the second value (e.g., 1) of the first syntax element indicating that the traversal mode for the first connectivity is the dual degree traversal mode, and the third value (e.g., 2) of the first syntax element indicating that the traversal mode for the first connectivity is adaptive. When a value of the first syntax element is the third value, the coded information includes the second syntax element (e.g., gcc_traversal) indicating the traversal mode for the first group (1410). The traversal mode is the polygon fan traversal mode or the dual degree traversal mode. When the second syntax element indicates that the traversal mode is the dual degree traversal mode, the coded information includes a syntax element (e.g., degree_vertex) indicating the vertex degree of the first group (1410) and a syntax element (e.g., degree_face) for each connected component in the first group (1410) indicating the face degree of the respective connected component.

In an aspect, the face degree mode is signaled once per group and the vertex degree mode is signaled per connected component as shown in Table 9.

TABLE 9

| | Descriptor |
|---|---|
| connected_components_data( ) { | |
| Slice header | |
| geo_traversal_mode | ue(v) |
| Group CC header | |
| if (geo_traversal_mode == 2) { | |
| gcc_traversal | u(1) |
| num_cc_in_group | ACExpGolomb |
| if (gcc_traversal == 1) { | |
| degree_face | ue(v) |
| } | |
| } | |
| CC header | |
| if (geo_traversal_mode == 2) { | |
| if (gcc_traversal == 1) { | |
| degree_vertex | ue(v) |
| } | |
| } | |

geo_traversal_mode indicates whether one or more traversal strategies are used. geo_traversal_mode being equal to 0 indicates the polygon fan traversal only, geo_traversal_mode being equal to 1 indicates the dual degree traversal only, and geo_traversal_mode being equal to 2 indicates every connected component has its own optimal traversal (e.g., the adaptive mode is used). geo_traversal_mode equal to k specifies whether the traversal mode is the polygon fan traversal, the dual degree traversal only, or the adaptive mode as described in Table 3. gcc_traversal equal to 0 specifies the polygon fan traversal for the group. gcc_traversal equal to 1 specifies the dual degree traversal for the group. num_cc_in_group is the number of connected components in the group signaled, for example, using a combination of arithmetic coding and exponential Golomb coding. degree_face equal to k specifies the face degree of the group to be equal to n as described in Table 4. degree_vertex equal to k specifics the vertex degree per connected component in the group to be equal to n as described in Table 5.

In an example, such as shown in Table 9 and referring to FIG. 14, the coded information includes the first syntax element such as geo_traversal_mode indicating whether the traversal mode for the first connectivity of the first group (1410) is adaptive. As shown in Table 3, the first value (e.g., 0) of the first syntax element indicating that the traversal mode for the first connectivity is the polygon fan traversal mode, the second value (e.g., 1) of the first syntax element indicating that the traversal mode for the first connectivity is the dual degree traversal mode, and the third value (e.g., 2) of the first syntax element indicating that the traversal mode for the first connectivity is adaptive. When a value of the first syntax element is the third value, the coded information includes the second syntax element (e.g., gcc_traversal) indicating the traversal mode for the first group (1410). The traversal mode is the polygon fan traversal mode or the dual degree traversal mode. When the second syntax element indicates that the traversal mode is the dual degree traversal mode, the coded information includes a syntax element (e.g., degree_face) indicating the face degree of the first group (1410) and a syntax element (e.g., degree_vertex) for each connected component in the first group (1410) indicating the vertex degree of the respective connected component.

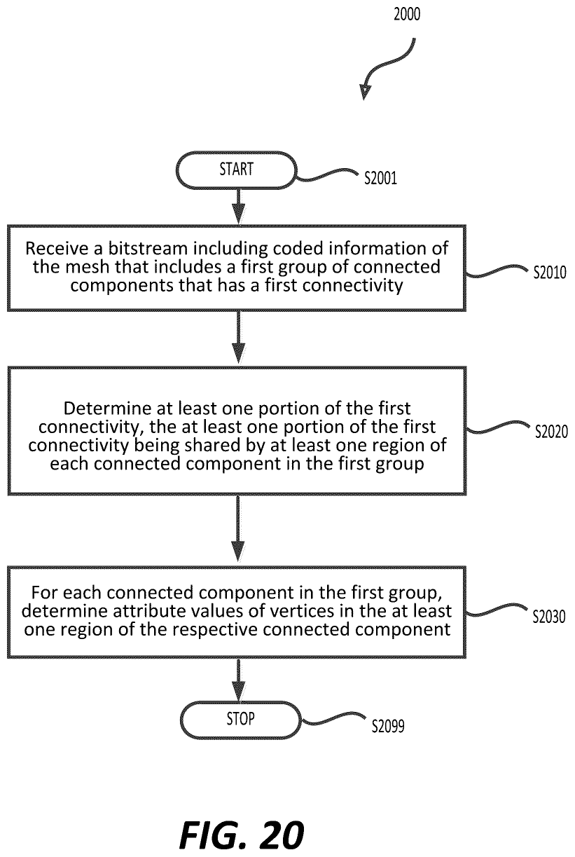

FIG. 20 shows a flow chart outlining a process (2000) according to an aspect of the disclosure. The process (2000) can be used in an apparatus. The apparatus may include a mesh decoder, such as a video decoder. The video decoder is configured to, for example, decode one or more meshes. In various aspects, the process (2000) is executed by processing circuitry, such as the processing circuitry that performs functions of the video decoder (110), the processing circuitry that performs functions of the video decoder (210), the mesh decoder, and/or the like. In some aspects, the process (2000) is implemented in software instructions, thus when the processing circuitry executes the software instructions, the processing circuitry performs the process (2000). The process starts at (S2001) and proceeds to (S2010).

At (S2010), a bitstream including coded information of the mesh that includes a first group of connected components that has a first connectivity is received.

At (S2020), at least one portion of the first connectivity is determined. The at least one portion of the first connectivity is shared by at least one region of each connected component in the first group.

At (S2030), for each connected component in the first group, attribute values of vertices in the at least one region of the respective connected component are determined. Then, the process proceeds to (S2099) and terminates.

The process (2000) can be suitably adapted. Step(s) in the process (2000) can be modified and/or omitted. Additional step(s) can be added. Any suitable order of implementation can be used.

In some aspects, the at least one portion of the first connectivity is a first one of a plurality of portions of the first connectivity; for each connected component in the first group, the at least one region of the respective connected component is a first region of the respective connected component; and the process (2000) further includes: determining a number of the connected components in the first group; and after determining the first one of the plurality of portions of the first connectivity and determining, for each connected component in the first group, the attribute values of the vertices in the first region of the respective connected component, determining a second portion of the plurality of portions of the first connectivity, the second portion of the plurality of portions of the first connectivity being shared by second regions of the respective connected components in the first group; and for each connected component in the first group, determining attribute values of vertices in the second region of the respective connected component.

In some aspects, the at least one portion of the first connectivity is the first connectivity; for each connected component in the first group, the at least one region of the respective connected component is the respective connected component; and the process (2000) further includes determining a number of the connected components in the first group.

In some aspects, the mesh includes a plurality of groups of connected components, each group of connected components shares a respective connectivity, the plurality of groups includes a first subset of groups and a second subset of groups, the first subset of groups includes the first group, each of the first subset of groups has more than one connected component, and each of the second subset of groups has only one connected component. The process (2000) includes: sorting the plurality of groups based on numbers of connected components in the respective groups where the second subset of groups is decoded after decoding the first subset of groups and the number of the connected components in the first group is the largest among the numbers of connected components in the respective groups. The process (2000) includes: for each group that is different from the first group, determining a number of connected components of the respective group when a number of connected components of a previously decoded group is larger than 1; determining the connectivity of the respective group; and for each connected component in the respective group, determining attribute values of vertices in the respective connected component.

In some aspects, the mesh includes a plurality of groups of connected components, each group of connected components shares a respective connectivity, and the plurality of groups includes the first group. The process (2000) includes: sorting the plurality of groups based on numbers of connected components in the respective groups where the number of the connected components in the first group is the largest among the numbers of connected components in the respective groups. The process (2000) includes: for each group that is different from the first group, determining a current number of connected components of the respective group based on a previous number of connected components of a previously decoded group and a difference between the current number and the previous number; determining the connectivity of the respective group; and for each connected component in the respective group, determining attribute values of vertices in the respective connected component.

In some aspects, the attribute values are the determined as follows: for each connected component in the first group, determining predictor indices for the respective attribute values of the vertices in the respective connected component; and determining the attribute values of the vertices in the respective connected component based on the respective predictor indices.

In some aspects, the process (2000) includes: for a first connected component in the first group, determining predictor indices for the respective attribute values of the vertices in the first connected component. The attribute values are determined as follows: for each connected component in the first group, determining the attribute values of the vertices in the respective connected component based on the predictor indices.

In some aspects, the attribute values are determined as follows: for a current connected component in the first group, determining initial attribute values of the vertices in the current connected component; and determining the attribute values of the vertices in the current connected component based on the initial attribute values and corresponding residues of a connected component that is decoded prior to decoding remaining connected components in the first group. The remaining connected components include the current connected component.

In some aspects, the attribute values are determined as follows: for a current connected component in the first group, determining initial attribute values of the vertices in the current connected component; and determining the attribute values of the vertices in the current connected component based on the initial attribute values and corresponding residues of a connected component that is decoded prior to decoding the current connected component in a decoding order.

In some aspects, the coded information includes a flag indicating that the mesh includes at least one group, each of the at least one group has two or more connected components that have a same connectivity, and the at least one group includes the first group.

In some aspects, the coded information includes a first syntax element indicating whether a traversal mode for each of a plurality of connected components in the mesh is adaptive, the plurality of connected components does not include connected components in the first group, a first value of the first syntax element indicates that the traversal mode for each of the plurality of connected components is a polygon fan traversal mode, a second value of the first syntax element indicates that the traversal mode for each of the plurality of connected components is a dual degree traversal mode, and a third value of the first syntax element indicates that the traversal mode for each of the plurality of connected components is adaptive. When a value of the first syntax element is the third value, the coded information includes a second syntax element indicating the traversal mode for one of the plurality of connected components, and the traversal mode is the polygon fan traversal mode or the dual degree traversal mode. When the second syntax element indicates that the traversal mode is the dual degree traversal mode, the coded information includes a third syntax element indicating a face degree of the one of the plurality of connected components and a fourth syntax element indicating a vertex degree of the one of the plurality of connected components.

In some aspects, the coded information includes a first syntax element indicating whether a traversal mode for the first connectivity of the first group is adaptive, a first value of the first syntax element indicates that the traversal mode for the first connectivity is a polygon fan traversal mode, a second value of the first syntax element indicates that the traversal mode for the first connectivity is a dual degree traversal mode, and a third value of the first syntax element indicates that the traversal mode for the first connectivity is adaptive. When a value of the first syntax element is the third value, the coded information includes a second syntax element indicating the traversal mode for the first group, the traversal mode is the polygon fan traversal mode or the dual degree traversal mode. When the second syntax element indicates that the traversal mode is the dual degree traversal mode, the coded information includes a third syntax element indicating a face degree of the first group and a fourth syntax element indicating a vertex degree of the first group.

In some aspects, the coded information includes a first syntax element indicating whether a traversal mode for the first connectivity of the first group is adaptive, a first value of the first syntax element indicates that the traversal mode for the first connectivity is a polygon fan traversal mode, a second value of the first syntax element indicates that the traversal mode for the first connectivity is a dual degree traversal mode, and a third value of the first syntax element indicates that the traversal mode for the first connectivity is adaptive. When a value of the first syntax element is the third value, the coded information includes a second syntax element indicating the traversal mode for the first group, the traversal mode is the polygon fan traversal mode or the dual degree traversal mode. When the second syntax element indicates that the traversal mode is the dual degree traversal mode, the coded information includes a third syntax element for each connected component in the first group indicating a face degree of the respective connected component and a fourth syntax element for the respective connected component indicating a vertex degree of the respective connected component.

In some aspects the coded information includes a first syntax element indicating whether a traversal mode for the first connectivity of the first group is adaptive, a first value of the first syntax element indicates that the traversal mode for the first connectivity is a polygon fan traversal mode, a second value of the first syntax element indicates that the traversal mode for the first connectivity is a dual degree traversal mode, and a third value of the first syntax element indicates that the traversal mode for the first connectivity is adaptive. When a value of the first syntax element is the third value, the coded information includes a second syntax element indicating the traversal mode for the first group, the traversal mode is the polygon fan traversal mode or the dual degree traversal mode. When the second syntax element indicates that the traversal mode is the dual degree traversal mode, the coded information includes a third syntax element indicating a vertex degree of the first group; and the coded information includes a fourth syntax element for each connected component indicating a face degree of the respective connected component.

In some aspects, the coded information includes a first syntax element indicating whether a traversal mode for the first connectivity of the first group is adaptive, a first value of the first syntax element indicates that the traversal mode for the first connectivity is a polygon fan traversal mode, a second value of the first syntax element indicates that the traversal mode for the first connectivity is a dual degree traversal mode, and a third value of the first syntax element indicates that the traversal mode for the first connectivity is adaptive. When a value of the first syntax element is the third value, the coded information includes a second syntax element indicating the traversal mode for the first group, the traversal mode is the polygon fan traversal mode or the dual degree traversal mode. When the second syntax element indicates that the traversal mode is the dual degree traversal mode, the coded information includes a third syntax element indicating a face degree of the first group, and the coded information includes a fourth syntax element for each connected component indicating a vertex degree of the respective connected component.

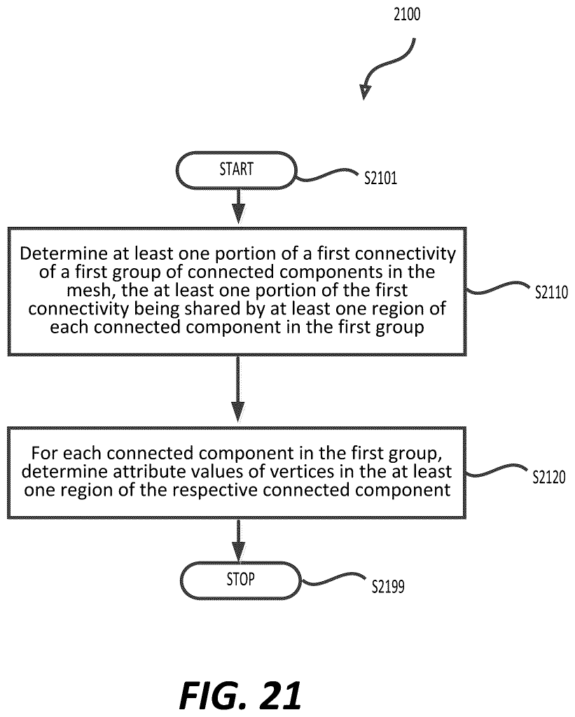

FIG. 21 shows a flow chart outlining a process (2100) according to an aspect of the disclosure. The process (2100) can be used in an apparatus. The apparatus may include a mesh encoder, such as a video encoder. The video encoder is configured to, for example, to encode one or more meshes. In various aspects, the process (2100) is executed by processing circuitry, such as the processing circuitry that performs functions of the video encoder (103), the processing circuitry that performs functions of the video encoder (303), the mesh encoder, and/or the like. In some aspects, the process (2100) is implemented in software instructions, thus when the processing circuitry executes the software instructions, the processing circuitry performs the process (2100). The process starts at (S2101) and proceeds to (S2110).

At (S2110), at least one portion of a first connectivity of a first group of connected components in a mesh is determined. The at least one portion of the first connectivity is shared by at least one region of each connected component in the first group.

At (S2120), for each connected component in the first group, attribute values of vertices in the at least one region of the respective connected component are determined.

Then, the process proceeds to (S2199) and terminates.

The process (2100) can be suitably adapted. Step(s) in the process (2100) can be modified and/or omitted. Additional step(s) can be added. Any suitable order of implementation can be used.

In some aspects, the at least one portion of the first connectivity is a first one of a plurality of portions of the first connectivity. For each connected component in the first group, the at least one region of the respective connected component is a first region of the respective connected component. The process (2100) includes: determining a number of the connected components in the first group; and after determining the first one of the plurality of portions of the first connectivity and determining, for each connected component in the first group, the attribute values of the vertices in the first region of the respective connected component, determining a second portion of the plurality of portions of the first connectivity where the second portion of the plurality of portions of the first connectivity is shared by second regions of the respective connected components in the first group. The process (2100) includes: for each connected component in the first group, determining attribute values of vertices in the second region of the respective connected component.

In some aspects, the at least one portion of the first connectivity is the first connectivity; for each connected component in the first group, the at least one region of the respective connected component is the respective connected component; and The process (2100) further includes determining a number of the connected components in the first group.

In some aspects, the mesh includes a plurality of groups of connected components, each group of connected components shares a respective connectivity, the plurality of groups includes a first subset of groups and a second subset of groups, the first subset of groups includes the first group, each of the first subset of groups has more than one connected component, each of the second subset of groups has only one connected component. The process (2100) includes: sorting the plurality of groups based on numbers of connected components in the respective groups where the second subset of groups is encoded after encoding the first subset of groups and the number of the connected components in the first group is the largest among the numbers of connected components in the respective groups. The process (2100) includes: for each group that is different from the first group, determining a number of connected components of the respective group when a number of connected components of a previously decoded group is larger than 1; determining the connectivity of the respective group; and for each connected component in the respective group, determining attribute values of vertices in the respective connected component.

In some aspects, the techniques described herein relate to a non-transitory computer-readable storage medium storing instructions which when executed by a processor cause the processor to perform an encoding method comprising: determining at least one portion of a first connectivity of a first group of connected components in the mesh, the at least one portion of the first connectivity being shared by at least one region of each connected component in the first group; and for each connected component in the first group, determining attribute values of vertices in the at least one region of the respective connected component. In an example, the encoding method includes transmitting a video bitstream including the mesh.

In an aspect, a non-transitory computer-readable storage medium is provided. The non-transitory computer-readable storage medium storing a video bitstream which when processed by a processor cause the processor to perform any of the described methods. In an example, the video bitstream includes coded information of the mesh that includes a first group of connected components that has a first connectivity. At least one portion of the first connectivity is determined. The at least one portion of the first connectivity is shared by at least one region of each connected component in the first group. For each connected component in the first group, attribute values of vertices in the at least one region of the respective connected component are determined.

In an aspect, a method of processing a mesh includes processing a bitstream of the mesh according to a format rule. For example, the bitstream is a bitstream that is decoded/encoded in any of the decoding and/or encoding methods described herein. The format rule may specify one or more constraints of the bitstream and/or one or more processes to be performed by the decoder and/or encoder.

In an aspect, the bitstream includes coded information of the mesh that includes a first group of connected components that has a first connectivity. The format rule specifies that at least one portion of the first connectivity is determined. The at least one portion of the first connectivity is shared by at least one region of each connected component in the first group. The format rule specifies that for each connected component in the first group, attribute values of vertices in the at least one region of the respective connected component are determined.

The methods, aspects, and examples in the disclosure may be used separately or combined in any order. For example, some aspects and/or examples performed by the decoder may be performed by the encoder and vice versa. Each of the methods (or aspects), an encoder, and a decoder may be implemented by processing circuitry (e.g., one or more processors or one or more integrated circuits). In one example, the one or more processors execute a program that is stored in a non-transitory computer-readable medium.

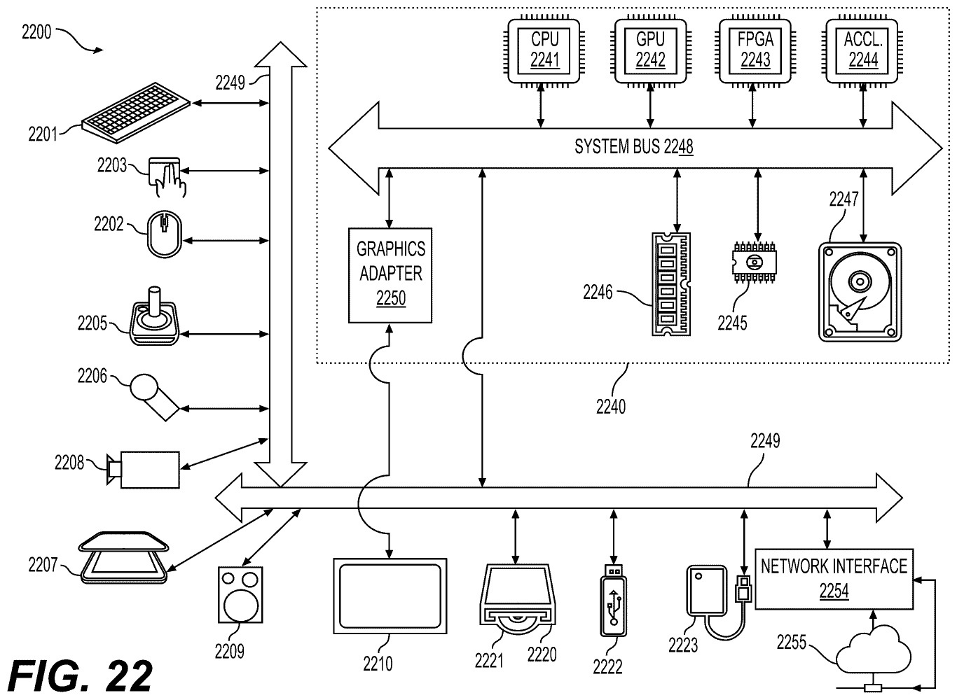

The techniques described above, can be implemented as computer software using computer-readable instructions and physically stored in one or more computer-readable media. For example, FIG. 22 shows a computer system (2200) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 22 for computer system (2200) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of a computer system (2200).

Computer system (2200) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (2201), mouse (2202), trackpad (2203), touch screen (2210), data-glove (not shown), joystick (2205), microphone (2206), scanner (2207), camera (2208).

Computer system (2200) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (2210), data-glove (not shown), or joystick (2205), but there can also be tactile feedback devices that do not serve as input devices), audio output devices (such as: speakers (2209), headphones (not depicted)), visual output devices (such as screens (2210) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (2200) can also include human accessible storage devices and their associated media such as optical media including CD/DVD ROM/RW (2220) with CD/DVD or the like media (2221), thumb-drive (2222), removable hard drive or solid state drive (2223), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (2200) can also include an interface (2254) to one or more communication networks (2255). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (2249) (such as, for example USB ports of the computer system (2200)); others are commonly integrated into the core of the computer system (2200) by attachment to a system bus as described below (for example Ethernet interface into a PC computer system or cellular network interface into a smartphone computer system). Using any of these networks, computer system (2200) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (2240) of the computer system (2200).

The core (2240) can include one or more Central Processing Units (CPU) (2241), Graphics Processing Units (GPU) (2242), specialized programmable processing units in the form of Field Programmable Gate Areas (FPGA) (2243), hardware accelerators for certain tasks (2244), graphics adapters (2250), and so forth. These devices, along with Read-only memory (ROM) (2245), Random-access memory (2246), internal mass storage such as internal non-user accessible hard drives, SSDs, and the like (2247), may be connected through a system bus (2248). In some computer systems, the system bus (2248) can be accessible in the form of one or more physical plugs to enable extensions by additional CPUs, GPU, and the like. The peripheral devices can be attached either directly to the core's system bus (2248), or through a peripheral bus (2249). In an example, the screen (2210) can be connected to the graphics adapter (2250). Architectures for a peripheral bus include PCI, USB, and the like.

CPUs (2241), GPUs (2242), FPGAs (2243), and accelerators (2244) can execute certain instructions that, in combination, can make up the aforementioned computer code. That computer code can be stored in ROM (2245) or RAM (2246). Transitional data can also be stored in RAM (2246), whereas permanent data can be stored for example, in the internal mass storage (2247). Fast storage and retrieve to any of the memory devices can be enabled through the use of cache memory, that can be closely associated with one or more CPU (2241), GPU (2242), mass storage (2247), ROM (2245), RAM (2246), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (2200), and specifically the core (2240) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (2240) that are of non-transitory nature, such as core-internal mass storage (2247) or ROM (2245). The software implementing various aspects of the present disclosure can be stored in such devices and executed by core (2240). A computer-readable medium can include one or more memory devices or chips, according to particular needs. The software can cause the core (2240) and specifically the processors therein (including CPU, GPU, FPGA, and the like) to execute particular processes or particular parts of particular processes described herein, including defining data structures stored in RAM (2246) and modifying such data structures according to the processes defined by the software. In addition or as an alternative, the computer system can provide functionality as a result of logic hardwired or otherwise embodied in a circuit (for example: accelerator (2244)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.

(1) A method for decoding a mesh, the method including: receiving a bitstream including coded information of the mesh that includes a first group of connected components that has a first connectivity; determining at least one portion of the first connectivity, the at least one portion of the first connectivity being shared by at least one region of each connected component in the first group; and for each connected component in the first group, determining attribute values of vertices in the at least one region of the respective connected component.

(2) The method of feature (1), in which the at least one portion of the first connectivity is a first one of a plurality of portions of the first connectivity; for each connected component in the first group, the at least one region of the respective connected component is a first region of the respective connected component; and the method further includes: determining a number of the connected components in the first group; and after determining the first one of the plurality of portions of the first connectivity and determining, for each connected component in the first group, the attribute values of the vertices in the first region of the respective connected component, determining a second portion of the plurality of portions of the first connectivity, the second portion of the plurality of portions of the first connectivity being shared by second regions of the respective connected components in the first group; and for each connected component in the first group, determining attribute values of vertices in the second region of the respective connected component.

(3) The method of feature (1), in which the at least one portion of the first connectivity is the first connectivity; for each connected component in the first group, the at least one region of the respective connected component is the respective connected component; and the method further includes determining a number of the connected components in the first group.

(4) The method of feature (3), in which the mesh includes a plurality of groups of connected components, each group of connected components sharing a respective connectivity, the plurality of groups including a first subset of groups and a second subset of groups, the first subset of groups including the first group, each of the first subset of groups having more than one connected component, each of the second subset of groups having only one connected component; the method includes: sorting the plurality of groups based on numbers of connected components in the respective groups, the second subset of groups being decoded after decoding the first subset of groups, the number of the connected components in the first group being the largest among the numbers of connected components in the respective groups; for each group that is different from the first group, determining a number of connected components of the respective group when a number of connected components of a previously decoded group is larger than 1; determining the connectivity of the respective group; and for each connected component in the respective group, determining attribute values of vertices in the respective connected component.

(5) The method of feature (3), in which the mesh includes a plurality of groups of connected components, each group of connected components sharing a respective connectivity, the plurality of groups including the first group; the method includes: sorting the plurality of groups based on numbers of connected components in the respective groups, the number of the connected components in the first group being the largest among the numbers of connected components in the respective groups; and for each group that is different from the first group, determining a current number of connected components of the respective group based on a previous number of connected components of a previously decoded group and a difference between the current number and the previous number; determining the connectivity of the respective group; and for each connected component in the respective group, determining attribute values of vertices in the respective connected component.

(6) The method of feature (3), in which the determining the attribute values comprises: for each connected component in the first group, determining predictor indices for the respective attribute values of the vertices in the respective connected component; and determining the attribute values of the vertices in the respective connected component based on the respective predictor indices.

(7) The method of feature (3), further including: for a first connected component in the first group, determining predictor indices for the respective attribute values of the vertices in the first connected component, wherein the determining the attribute values includes, for each connected component in the first group, determining the attribute values of the vertices in the respective connected component based on the predictor indices.

(8) The method of feature (3), in which the determining the attribute values comprises: for a current connected component in the first group, determining initial attribute values of the vertices in the current connected component; and determining the attribute values of the vertices in the current connected component based on the initial attribute values and corresponding residues of a connected component that is decoded prior to decoding remaining connected components in the first group, the remaining connected components including the current connected component.

(9) The method of feature (3), in which the determining the attribute values comprises: for a current connected component in the first group, determining initial attribute values of the vertices in the current connected component; and determining the attribute values of the vertices in the current connected component based on the initial attribute values and corresponding residues of a connected component that is decoded prior to decoding the current connected component in a decoding order.

(10) The method of any of features (1)-(9), in which the coded information includes a flag indicating that the mesh includes at least one group, each of the at least one group having two or more connected components that have a same connectivity, the at least one group including the first group.

(11) The method of any of features (1)-(10), in which the coded information includes a first syntax element indicating whether a traversal mode for each of a plurality of connected components in the mesh is adaptive, the plurality of connected components not including connected components in the first group, a first value of the first syntax element indicating that the traversal mode for each of the plurality of connected components is a polygon fan traversal mode, a second value of the first syntax element indicating that the traversal mode for each of the plurality of connected components is a dual degree traversal mode, and a third value of the first syntax element indicating that the traversal mode for each of the plurality of connected components is adaptive; when a value of the first syntax element is the third value, the coded information includes a second syntax element indicating the traversal mode for one of the plurality of connected components, the traversal mode being the polygon fan traversal mode or the dual degree traversal mode; and when the second syntax element indicates that the traversal mode is the dual degree traversal mode, the coded information includes a third syntax element indicating a face degree of the one of the plurality of connected components and a fourth syntax element indicating a vertex degree of the one of the plurality of connected components.

(12) The method of any of features (1)-(10), in which the coded information includes a first syntax element indicating whether a traversal mode for the first connectivity of the first group is adaptive, a first value of the first syntax element indicating that the traversal mode for the first connectivity is a polygon fan traversal mode, a second value of the first syntax element indicating that the traversal mode for the first connectivity is a dual degree traversal mode, and a third value of the first syntax element indicating that the traversal mode for the first connectivity is adaptive; when a value of the first syntax element is the third value, the coded information includes a second syntax element indicating the traversal mode for the first group, the traversal mode being the polygon fan traversal mode or the dual degree traversal mode; and when the second syntax element indicates that the traversal mode is the dual degree traversal mode, the coded information includes a third syntax element indicating a face degree of the first group and a fourth syntax element indicating a vertex degree of the first group.

(13) The method of any of features (1)-(10), in which the coded information includes a first syntax element indicating whether a traversal mode for the first connectivity of the first group is adaptive, a first value of the first syntax element indicating that the traversal mode for the first connectivity is a polygon fan traversal mode, a second value of the first syntax element indicating that the traversal mode for the first connectivity is a dual degree traversal mode, and a third value of the first syntax element indicating that the traversal mode for the first connectivity is adaptive; when a value of the first syntax element is the third value, the coded information includes a second syntax element indicating the traversal mode for the first group, the traversal mode being the polygon fan traversal mode or the dual degree traversal mode; and when the second syntax element indicates that the traversal mode is the dual degree traversal mode, the coded information includes a third syntax element for each connected component in the first group indicating a face degree of the respective connected component and a fourth syntax element for the respective connected component indicating a vertex degree of the respective connected component.

(14) The method of any of features (1)-(10), in which the coded information includes a first syntax element indicating whether a traversal mode for the first connectivity of the first group is adaptive, a first value of the first syntax element indicating that the traversal mode for the first connectivity is a polygon fan traversal mode, a second value of the first syntax element indicating that the traversal mode for the first connectivity is a dual degree traversal mode, and a third value of the first syntax element indicating that the traversal mode for the first connectivity is adaptive; when a value of the first syntax element is the third value, the coded information includes a second syntax element indicating the traversal mode for the first group, the traversal mode being the polygon fan traversal mode or the dual degree traversal mode; and when the second syntax element indicates that the traversal mode is the dual degree traversal mode, the coded information includes a third syntax element indicating a vertex degree of the first group; and the coded information includes a fourth syntax element for each connected component indicating a face degree of the respective connected component.

(15) The method of any of features (1)-(10), in which the coded information includes a first syntax element indicating whether a traversal mode for the first connectivity of the first group is adaptive, a first value of the first syntax element indicating that the traversal mode for the first connectivity is a polygon fan traversal mode, a second value of the first syntax element indicating that the traversal mode for the first connectivity is a dual degree traversal mode, and a third value of the first syntax element indicating that the traversal mode for the first connectivity is adaptive; when a value of the first syntax element is the third value, the coded information includes a second syntax element indicating the traversal mode for the first group, the traversal mode being the polygon fan traversal mode or the dual degree traversal mode; and when the second syntax element indicates that the traversal mode is the dual degree traversal mode, the coded information includes a third syntax element indicating a face degree of the first group; and the coded information includes a fourth syntax element for each connected component indicating a vertex degree of the respective connected component.

(16) A method for encoding a mesh, the method including: determining at least one portion of a first connectivity of a first group of connected components in the mesh, the at least one portion of the first connectivity being shared by at least one region of each connected component in the first group; and for each connected component in the first group, determining attribute values of vertices in the at least one region of the respective connected component.

(17) The method of feature (16), in which the at least one portion of the first connectivity is a first one of a plurality of portions of the first connectivity; for each connected component in the first group, the at least one region of the respective connected component is a first region of the respective connected component; and the method further includes: determining a number of the connected components in the first group; and after determining the first one of the plurality of portions of the first connectivity and determining, for each connected component in the first group, the attribute values of the vertices in the first region of the respective connected component, determining a second portion of the plurality of portions of the first connectivity, the second portion of the plurality of portions of the first connectivity being shared by second regions of the respective connected components in the first group; and for each connected component in the first group, determining attribute values of vertices in the second region of the respective connected component.

(18) The method of feature (16), in which the at least one portion of the first connectivity is the first connectivity; for each connected component in the first group, the at least one region of the respective connected component is the respective connected component; and the method further includes determining a number of the connected components in the first group.

(19) The method of feature (18), in which the mesh includes a plurality of groups of connected components, each group of connected components sharing a respective connectivity, the plurality of groups including a first subset of groups and a second subset of groups, the first subset of groups including the first group, each of the first subset of groups having more than one connected component, each of the second subset of groups having only one connected component; the method includes: sorting the plurality of groups based on numbers of connected components in the respective groups, the second subset of groups being encoded after encoding the first subset of groups, the number of the connected components in the first group being the largest among the numbers of connected components in the respective groups; for each group that is different from the first group, determining a number of connected components of the respective group when a number of connected components of a previously decoded group is larger than 1; determining the connectivity of the respective group; and for each connected component in the respective group, determining attribute values of vertices in the respective connected component.

(20) A non-transitory computer-readable storage medium storing instructions which when executed by a processor cause the processor to perform an encoding method comprising: determining at least one portion of a first connectivity of a first group of connected components in the mesh, the at least one portion of the first connectivity being shared by at least one region of each connected component in the first group; for each connected component in the first group, determining attribute values of vertices in the at least one region of the respective connected component; and transmitting a video bitstream including the mesh.

(21) An apparatus for video decoding, including processing circuitry that is configured to perform the method of any of features (1) to (15).

(22) An apparatus for video encoding, including processing circuitry that is configured to perform the method of any of features (16) to (19).

(23) A non-transitory computer-readable storage medium storing instructions which when executed by at least one processor cause the at least one processor to perform the method of any of features (1) to (19).

What is claimed is:

1. A method for decoding a mesh, the method comprising:
receiving a bitstream including coded information of the mesh that includes a first group of connected components that has a first connectivity;
determining at least one portion of the first connectivity, the at least one portion of the first connectivity being shared by at least one region of each connected component in the first group; and
for each connected component in the first group, determining attribute values of vertices in the at least one region of the respective connected component.

2. The method of claim 1, wherein
the at least one portion of the first connectivity is a first one of a plurality of portions of the first connectivity;
for each connected component in the first group, the at least one region of the respective connected component is a first region of the respective connected component; and
the method further includes:
determining a number of the connected components in the first group; and
after determining the first one of the plurality of portions of the first connectivity and determining, for each connected component in the first group, the attribute values of the vertices in the first region of the respective connected component,
determining a second portion of the plurality of portions of the first connectivity, the second portion of the plurality of portions of the first connectivity being shared by second regions of the respective connected components in the first group; and
for each connected component in the first group, determining attribute values of vertices in the second region of the respective connected component.

3. The method of claim 1, wherein
the at least one portion of the first connectivity is the first connectivity;
for each connected component in the first group, the at least one region of the respective connected component is the respective connected component; and
the method further includes determining a number of the connected components in the first group.

4. The method of claim 3, wherein
the mesh includes a plurality of groups of connected components, each group of connected components sharing a respective connectivity, the plurality of groups including a first subset of groups and a second subset of groups, the first subset of groups including the first group, each of the first subset of groups having more than one connected component, each of the second subset of groups having only one connected component;
the method includes:
sorting the plurality of groups based on numbers of connected components in the respective groups, the second subset of groups being decoded after decoding the first subset of groups, the number of the connected components in the first group being the largest among the numbers of connected components in the respective groups;
for each group that is different from the first group,
determining a number of connected components of the respective group when a number of connected components of a previously decoded group is larger than 1;
determining the connectivity of the respective group; and
for each connected component in the respective group, determining attribute values of vertices in the respective connected component.

5. The method of claim 3, wherein
the mesh includes a plurality of groups of connected components, each group of connected components sharing a respective connectivity, the plurality of groups including the first group;
the method includes:
sorting the plurality of groups based on numbers of connected components in the respective groups, the number of the connected components in the first group being the largest among the numbers of connected components in the respective groups; and
for each group that is different from the first group,
determining a current number of connected components of the respective group based on a previous number of connected components of a previously decoded group and a difference between the current number and the previous number;
determining the connectivity of the respective group; and
for each connected component in the respective group, determining attribute values of vertices in the respective connected component.

6. The method of claim 3, wherein the determining the attribute values comprises:
for each connected component in the first group,
determining predictor indices for the respective attribute values of the vertices in the respective connected component; and
determining the attribute values of the vertices in the respective connected component based on the respective predictor indices.

7. The method of claim 3, further comprising:
for a first connected component in the first group, determining predictor indices for the respective attribute values of the vertices in the first connected component,
wherein the determining the attribute values includes, for each connected component in the first group, determining the attribute values of the vertices in the respective connected component based on the predictor indices.

8. The method of claim 3, wherein the determining the attribute values comprises:
for a current connected component in the first group,
determining initial attribute values of the vertices in the current connected component; and
determining the attribute values of the vertices in the current connected component based on the initial attribute values and corresponding residues of a connected component that is decoded prior to decoding remaining connected components in the first group, the remaining connected components including the current connected component.

9. The method of claim 3, wherein the determining the attribute values comprises:
for a current connected component in the first group,
determining initial attribute values of the vertices in the current connected component; and
determining the attribute values of the vertices in the current connected component based on the initial attribute values and corresponding residues of a connected component that is decoded prior to decoding the current connected component in a decoding order.

10. The method of claim 1, wherein the coded information includes a flag indicating that the mesh includes at least one group, each of the at least one group having two or more connected components that have a same connectivity, the at least one group including the first group.

11. The method of claim 1, wherein
the coded information includes a first syntax element indicating whether a traversal mode for each of a plurality of connected components in the mesh is adaptive, the plurality of connected components not including connected components in the first group, a first value of the first syntax element indicating that the traversal mode for each of the plurality of connected components is a polygon fan traversal mode, a second value of the first syntax element indicating that the traversal mode for each of the plurality of connected components is a dual degree traversal mode, and a third value of the first syntax element indicating that the traversal mode for each of the plurality of connected components is adaptive;
when a value of the first syntax element is the third value, the coded information includes a second syntax element indicating the traversal mode for one of the plurality of connected components, the traversal mode being the polygon fan traversal mode or the dual degree traversal mode; and
when the second syntax element indicates that the traversal mode is the dual degree traversal mode, the coded information includes a third syntax element indicating a face degree of the one of the plurality of connected components and a fourth syntax element indicating a vertex degree of the one of the plurality of connected components.

12. The method of claim 1, wherein
the coded information includes a first syntax element indicating whether a traversal mode for the first connectivity of the first group is adaptive, a first value of the first syntax element indicating that the traversal mode for the first connectivity is a polygon fan traversal mode, a second value of the first syntax element indicating that the traversal mode for the first connectivity is a dual degree traversal mode, and a third value of the first syntax element indicating that the traversal mode for the first connectivity is adaptive;
when a value of the first syntax element is the third value, the coded information includes a second syntax element indicating the traversal mode for the first group, the traversal mode being the polygon fan traversal mode or the dual degree traversal mode; and
when the second syntax element indicates that the traversal mode is the dual degree traversal mode, the coded information includes a third syntax element indicating a face degree of the first group and a fourth syntax element indicating a vertex degree of the first group.

13. The method of claim 1, wherein
the coded information includes a first syntax element indicating whether a traversal mode for the first connectivity of the first group is adaptive, a first value of the first syntax element indicating that the traversal mode for the first connectivity is a polygon fan traversal mode, a second value of the first syntax element indicating that the traversal mode for the first connectivity is a dual degree traversal mode, and a third value of the first syntax element indicating that the traversal mode for the first connectivity is adaptive;
when a value of the first syntax element is the third value, the coded information includes a second syntax element indicating the traversal mode for the first group, the traversal mode being the polygon fan traversal mode or the dual degree traversal mode; and
when the second syntax element indicates that the traversal mode is the dual degree traversal mode, the coded information includes a third syntax element for each connected component in the first group indicating a face degree of the respective connected component and a fourth syntax element for the respective connected component indicating a vertex degree of the respective connected component.

14. The method of claim 1, wherein
the coded information includes a first syntax element indicating whether a traversal mode for the first connectivity of the first group is adaptive, a first value of the first syntax element indicating that the traversal mode for the first connectivity is a polygon fan traversal mode, a second value of the first syntax element indicating that the traversal mode for the first connectivity is a dual degree traversal mode, and a third value of the first syntax element indicating that the traversal mode for the first connectivity is adaptive;
when a value of the first syntax element is the third value, the coded information includes a second syntax element indicating the traversal mode for the first group, the traversal mode being the polygon fan traversal mode or the dual degree traversal mode; and
when the second syntax element indicates that the traversal mode is the dual degree traversal mode,
the coded information includes a third syntax element indicating a vertex degree of the first group; and
the coded information includes a fourth syntax element for each connected component indicating a face degree of the respective connected component.

15. The method of claim 1, wherein
the coded information includes a first syntax element indicating whether a traversal mode for the first connectivity of the first group is adaptive, a first value of the first syntax element indicating that the traversal mode for the first connectivity is a polygon fan traversal mode, a second value of the first syntax element indicating that the traversal mode for the first connectivity is a dual degree traversal mode, and a third value of the first syntax element indicating that the traversal mode for the first connectivity is adaptive;
when a value of the first syntax element is the third value, the coded information includes a second syntax element indicating the traversal mode for the first group, the traversal mode being the polygon fan traversal mode or the dual degree traversal mode; and
when the second syntax element indicates that the traversal mode is the dual degree traversal mode,
the coded information includes a third syntax element indicating a face degree of the first group; and
the coded information includes a fourth syntax element for each connected component indicating a vertex degree of the respective connected component.

16. A method for encoding a mesh, the method comprising:
determining at least one portion of a first connectivity of a first group of connected components in the mesh, the at least one portion of the first connectivity being shared by at least one region of each connected component in the first group; and
for each connected component in the first group, determining attribute values of vertices in the at least one region of the respective connected component.

17. The method of claim 16, wherein
the at least one portion of the first connectivity is a first one of a plurality of portions of the first connectivity;
for each connected component in the first group, the at least one region of the respective connected component is a first region of the respective connected component; and
the method further includes:
determining a number of the connected components in the first group; and
after determining the first one of the plurality of portions of the first connectivity and determining, for each connected component in the first group, the attribute values of the vertices in the first region of the respective connected component,
determining a second portion of the plurality of portions of the first connectivity, the second portion of the plurality of portions of the first connectivity being shared by second regions of the respective connected components in the first group; and
for each connected component in the first group, determining attribute values of vertices in the second region of the respective connected component.

18. The method of claim 16, wherein
the at least one portion of the first connectivity is the first connectivity;
for each connected component in the first group, the at least one region of the respective connected component is the respective connected component; and
the method further includes determining a number of the connected components in the first group.

19. The method of claim 18, wherein
the mesh includes a plurality of groups of connected components, each group of connected components sharing a respective connectivity, the plurality of groups including a first subset of groups and a second subset of groups, the first subset of groups including the first group, each of the first subset of groups having more than one connected component, each of the second subset of groups having only one connected component;
the method includes:
sorting the plurality of groups based on numbers of connected components in the respective groups, the second subset of groups being encoded after encoding the first subset of groups, the number of the connected components in the first group being the largest among the numbers of connected components in the respective groups;
for each group that is different from the first group,
determining a number of connected components of the respective group when a number of connected components of a previously decoded group is larger than 1; and
determining the connectivity of the respective group; and
for each connected component in the respective group, determining attribute values of vertices in the respective connected component.

20. A non-transitory computer-readable storage medium storing instructions which when executed by a processor cause the processor to perform an encoding method comprising:
determining at least one portion of a first connectivity of a first group of connected components in a mesh, the at least one portion of the first connectivity being shared by at least one region of each connected component in the first group;
for each connected component in the first group, determining attribute values of vertices in the at least one region of the respective connected component; and
transmitting a video bitstream including the mesh.
